(19) United States
(12) Patent Application Publication
(10) Pub. No.: US 2010/0169470 A1
(43) Pub. Date: Jul. 1, 2010

(54) SYSTEM AND METHOD FOR OPERATIONAL MANAGEMENT OF COMPUTER SYSTEM

(75) Inventors: Souichi TAKASHIGE, Hachiouji (JP); Keisuke HATASAKI, Kawasaki (JP); Yoshifumi TAKAMOTO, Kokubunji (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/535,724

(22) Filed: Aug. 5, 2009

(30) Foreign Application Priority Data
Dec. 25, 2008 (JP) 2008-330885

(51) Int. Cl. G06F 15/173

(52) U.S. Cl. 709/223

(57) ABSTRACT

This invention provides a method for operational management in a management server of a computer system, the computer system comprising more than one server to be managed and an OS disk image adapted to operate on any one of the servers, the management server being used to manage association between the OS disk image and one of the servers to be managed. The operational management method includes acquiring I/O device recognition information that the OS disk image on a first server to be managed recognizes, then acquiring physical device configuration information that indicates an I/O device configuration of a second server to be managed, and determining, on the basis of the acquired I/O device recognition information and physical device configuration information, whether the OS disk image operates properly when loaded into the second server and executed.

This application claims priority based on a Japanese patent application, No. 2008-330885 filed on Dec. 25, 2008, the entire contents of which are incorporated herein by reference.

### BACKGROUND OF THE INVENTION

The present invention relates to a system and method for operational management of a computer system including a plurality of server computers.

The present invention relates to managing the operation of a computer system including at least one computer (hereinafter, termed a server) to execute business activities or operations of a company or the like.

The progress of computer storage technology and storage data management technology has allowed free modification of the data which defines the association between the central processing unit (CPU), memories, I/O devices, and other hardware becoming the execution entities of calculation in a computer, and the operating system (OS), business or service applications, and other software stored into storage devices. Hereinafter, these software products are called OS disk images. When loaded from a storage device into a main storage device, the software can be executed without any data settings.

For example, according to JP-A-2007-14013, in a configuration that uses Storage Area Network (SAN) storage devices, an OS and a specific server connected to the SAN can be exclusively associated with each other by creating a logical unit (LU) on one SAN storage device, then storing the OS into the LU in advance, and logically assigning LU access control only to that server by means of a SAN storage device or SAN switch control program. US2005/0216911 proposes another example, or a deployment method, in which an OS disk image is associated with a desired server by storing the OS disk image into a management server in advance and then copying (restoring) the OS disk image into a main storage device of the desired server which is to execute the OS disk image.

These techniques are catching attention since they allow easy implementation of the following forms of operation. In one operation form, in case of a server failure, the faulty server has its associated OS disk image reloaded into a standby server to allow the OS disk image to be executed for rapid continuation of the activity or service. In another operation form, an OS disk image that a server is to execute is swapped with another OS disk image and then the purpose of use of the server is switched according to time frame so that hardware of the server is shared among a plurality of services or activities to reduce hardware expenses.

### SUMMARY OF THE INVENTION

An OS uses a specific device driver program (hereinafter, referred to simply as a device driver) to control each of the I/O devices that a server has. These device drivers are dedicated programs for each I/O device such as a network interface card (NIC) or host bus adaptor (HBA). Information such as the identifier for the I/O device differs, even between I/O devices of the same kind. The OS sets the I/O device identifier and other information. For the deployment of an OS disk image or for operation with a change introduced in association-defining data of a first OS disk image with respect to a server by, for example, changing the connection destination of the first OS disk image to an LU in which a second OS disk image is stored, it is necessary that before the OS can operate properly, the OS should, when the association-defining data is changed, possess a device driver matching the I/O device configuration of the server with which the first OS disk image has been associated, and set appropriate information.

The information set for I/O devices includes logical information to be set for each I/O device, and physical information to be set using physical position information and/or physical characteristic information of the I/O device to be connected to a server. For NICs, for instance, IP addresses are set as logical information, and the IP addresses become associated with the characteristic MAC addresses of the NICs. In this case, even when a plurality of NICs of the same kind are connected to a server, the OS recognizes each NIC as a different device. Such information set for device drivers must match the I/O device before the OS can operate properly. To put it the other way around, before the OS can operate properly, the configuration of the I/O device must match the device driver and the OS disk image possessing the set information, and at the same time, the I/O device configuration, which can be physically redundant, that the OS disk image needs must be included.

The present invention provides, as an aspect thereof, a method for operational management in a management server of a computer system, the computer system comprising servers to be managed and an OS disk image adapted to operate on any one of the servers, the management server being used to manage association between the OS disk image and one of the servers to be managed, the method comprising the steps of: acquiring I/O device recognition information that the OS disk image on a first server to be managed recognizes, then acquiring physical device configuration information that indicates an I/O device configuration of a second server to be managed, and determining, on the basis of the acquired I/O device recognition information and physical device configuration information, whether the OS disk image operates properly when loaded into the second server and executed.

According to another aspect of the present invention, there is provided an operational management method allowing a management server to manage an OS disk image and a server in association with each other, the latter server being adapted to load and execute the OS disk image, the management server comprising an I/O device recognition table for storage of first information relating to an I/O device and used by the OS disk image, an I/O device configuration table for storage of second information relating to an I/O device and included in the latter server, the method comprising the steps of: determining whether the first information stored in the I/O device recognition table is included in the second information stored in the I/O device configuration information; and associating the OS disk image with the latter server when the first information stored in the I/O device recognition table is determined to be present in the second information stored in the I/O device configuration information.

In yet another aspect of the present invention, when part of first information stored in an I/O device recognition table is not included in second information stored in an I/O device configuration table, a management server changes the non-included information part in a range that even after the change has been conducted, an OS disk image is maintained in an executable state on a server. In addition, when the first information including the changed information part is included in the second information stored in the I/O device configuration table, the management server associates the OS disk image with the server.

According to the present invention, before an OS disk image is associated with a server, it can be verified whether the OS disk image operates properly on the server.

### BRIEF DESCRIPTION OF THE DRAWINGS

FIG. 1 shows an example of a computer system configuration;

FIG. 2 shows an example of a server (computer) configuration;

FIG. 3 shows an example of an OS disk image;

FIG. 4 shows an example of a management server configuration;

FIG. 5 is a diagram that shows association between a server physical configuration acquisition unit and a server-OS disk image associating program;

FIG. 6 shows an example of a server assignment state management table;

FIG. 7 shows an example of a server-OS disk image associating table;

FIG. 8 shows an example of an OS disk image-device recognition information associating table;

FIG. 9 shows an example of a device recognition information table;

FIGS. 10A and 10B are flowcharts of OS/device recognition information acquisition;

FIG. 11 shows an example of a physical-device configuration information send message structure;

FIG. 12 shows an OS state determination rule;

FIG. 13 is a flowchart of a state determination process in a combination of a server and an OS disk image;

FIGS. 14A and 14B are flowcharts of device configuration information acquisition from a physical server;

FIG. 15 is a flowchart of OS state determination;

FIG. 16 is another flowchart of a state determination process in a combination of a server and an OS disk image;

FIG. 17 is another system configuration diagram;

FIG. 18 shows an I/O device configuration table;

FIG. 19 shows an I/O device recognition table;

FIG. 20 shows yet another system configuration;

FIG. 21 is a flowchart of an I/O device configuration information acquisition program;

FIG. 22 shows a driver management table;

FIG. 23 shows another I/O device configuration table;

FIGS. 24A and 24B show other I/O device recognition tables;

FIG. 25 is another flowchart of OS state determination;

FIG. 26 shows a further system configuration;

FIG. 27 shows another example of a server (computer) configuration; and

FIG. 28 shows an OS disk image state determination table.

### DESCRIPTION OF THE PREFERRED EMBODIMENTS

Hereunder, embodiments of the present invention will be described using the accompanying drawings.

### First Embodiment

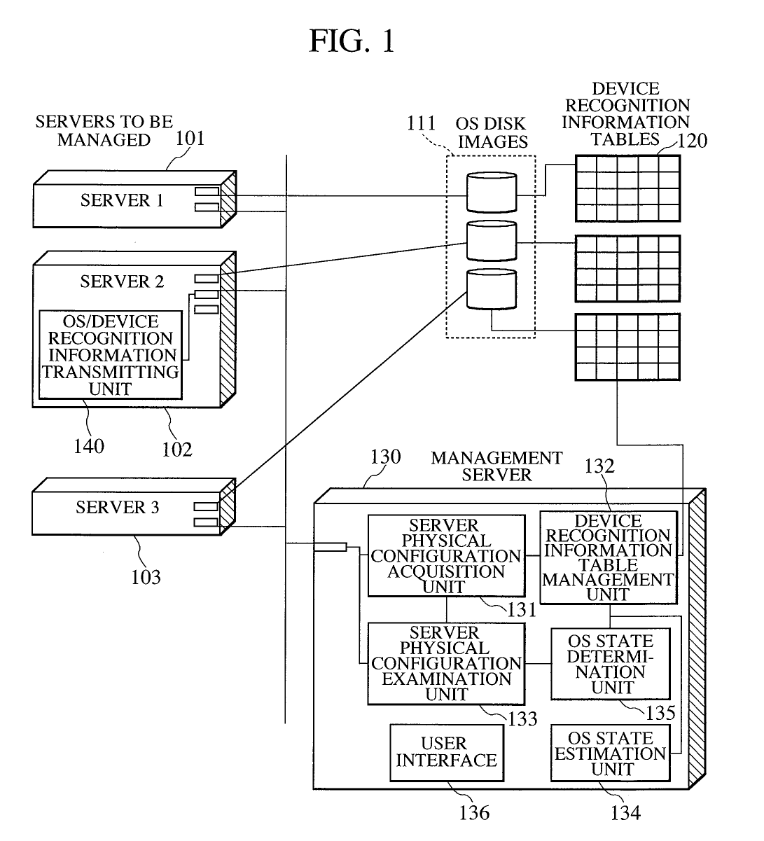

A computer system configuration according to a first embodiment is shown in FIG. 1. A server 101-103 to be managed is placed under management of a management server 130 (hereinafter, the server 101-103 is referred to simply as the server 101). The system of the present embodiment has more than one server. Various processing units 131 to 136 of the management server 130 will be described later herein. Operating system (OS) disk images 111 are programs (files) stored within an external storage, such as storage device, accessible from the management server 130 and the server 101. Details of the OS disk images 111 will also be described later herein. Device recognition information tables 120 are used by the management server 130, and one such specific table is provided in an associated state for each OS disk image 111.

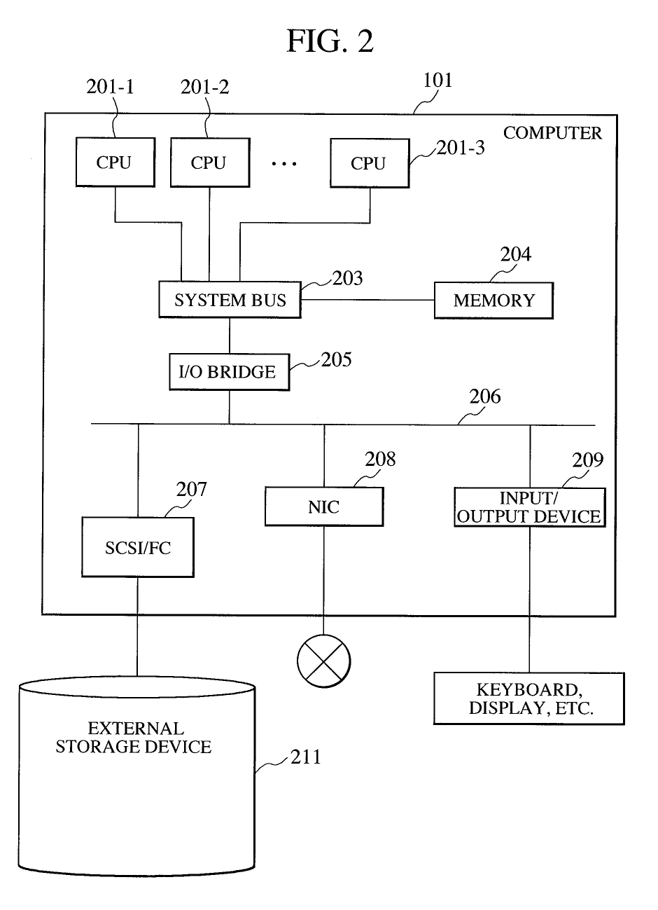

The server 101 is a computer of such a configuration as shown in FIG. 2. The server (computer) 101 includes a CPU 201 that executes programs, and a memory 204 that retains the programs and data. The CPU 201 and the memory 204 are interconnected by a system bus 203 that is a data access communication path to the memory 204. Also, a SCSI/FC (Small-Computer System Interface/Fiber Channel) 207, an NIC 208, an input/output device interface 209, and other interfaces are connected to the system bus 203 via IO bridges represented by PCI (Peripheral Component Interconnect). Operating systems, applications, and other programs are loaded into the memory 204 from the external storage device 211 and executed by the CPU 201.

A specific task is running on each server 101-103. Application programs concerning the task, and basic software such as the OS's, are included in the OS disk images 111. The OS disk images 111 refer to collectively the programs and data stored within the external storage device 211 or the like.

Examples of external storage device 211 include LUs present on an external storage device connected in a SAN or the like. In the present embodiment, the OS disk images 111 are described using LU-disposed disk contents as an example of their components. However, the OS disk images are not limited to images present on the LUs; the OS disk images may be contents of an internal disk, or as used in recent years for computer virtualization, they may be contents of a single huge file constructed virtually on any other OS file system.

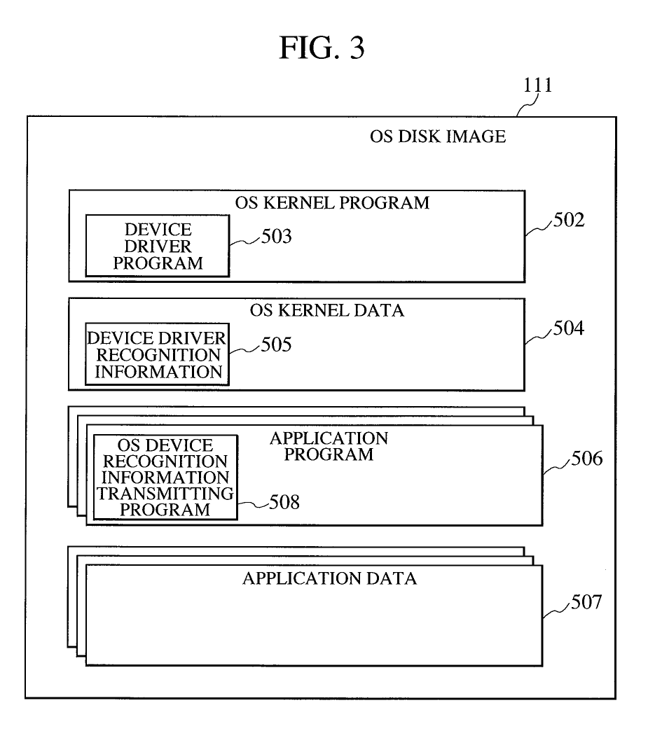

The example of the OS disk image components is shown in FIG. 3. Each OS disk image 111 includes an OS kernel program 502 inclusive of a device driver 503, OS kernel data 504 inclusive of device driver setup information 505, an application program 506, and application data 507. A sequence for loading the OS disk image into the server 101 and executing the loaded disk image is described below. The memory 204 of the server 101 has an internally prestored boot loader program. The boot loader program is stored in the memory 204 by an initial loader program provided as firmware which operates upon power-on of the server 101. The OS disk image is loaded into the memory 204 in response to an instruction of the OS disk image to be loaded into the boot loader program from the management server 130 (i.e., an instruction with an identifier of the LU having the OS disk image stored therein, an identifier of the OS disk image itself, and/or other parameters). Upon completion of loading, the boot loader program starts the OS kernel program 502. The OS kernel program 502 executes the application program 506 to start the task. As the application program 506 is executed, input/output commands and send/receive commands are issued. The OS kernel program 502 then uses the device driver 503 to execute these commands. The device driver program 503 operates in accordance with the device driver setup information 505, so the server 101 does not properly operate in cases that the device driver 503 or I/O device corresponding to the command is not present or that even in the presence of the device driver 503 or I/O device, the device driver setup information 505 does not match the I/O device to be connected to the server 101. The fact that the server 101 does not properly operate can mean that the OS does not operate properly.

Each OS disk image is managed by the management server 130, with the relevant device recognition information table 120 associated with the OS disk image. Information on the I/O device that the OS stored within the associated OS disk image 111 has recognized in the past is stored, together with the setup information of the corresponding device driver, in the device recognition information table 120. Details of the device recognition information table 120 will be described later.

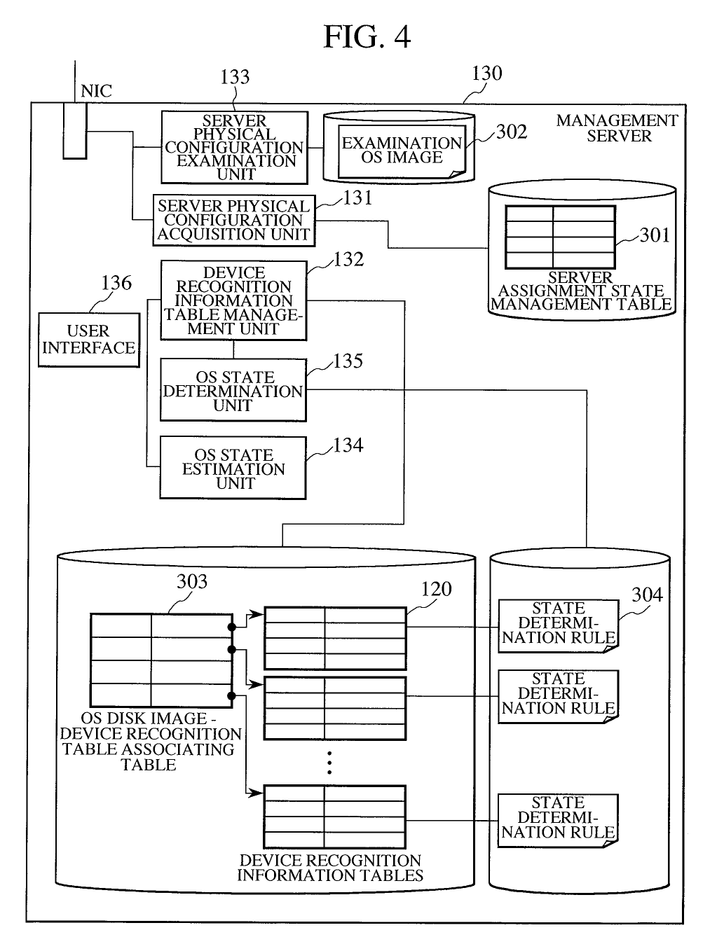

An example of a configuration of the management server 130 is shown in FIG. 4. The management server 130 has processing units. These units are a server physical configuration acquisition unit 131, a device recognition information table management unit 132, a server physical configuration examination unit 133, an OS state estimation unit 134, an OS state determination unit 135, and a user interface 136. The management server 130 also memorizes each device recognition information table 120, a server assignment state management table 301, an examination OS image 302, an OS disk image-device recognition table associating table 303, and state determination rules 304.

The server physical configuration acquisition unit 131 receives device recognition information transmitted from the server 101, and extracts differential information relative to contents of the corresponding device recognition information tables 120. The device recognition information table management unit 132 uses the extracted differential information to update the contents of each device recognition information table 120 associated with an OS disk image 111.

The server physical configuration examination unit 133 acquires a physical device configuration of the server 101.

The OS state estimation unit 134 estimates a behavior of the OS from the device recognition information stored in the device recognition information table management unit 132, and from the physical device configuration information acquired by the server physical configuration examination unit 133.

The OS state determination unit 135 uses estimation results of the OS state estimation unit 134 to judge whether the OS operates properly.

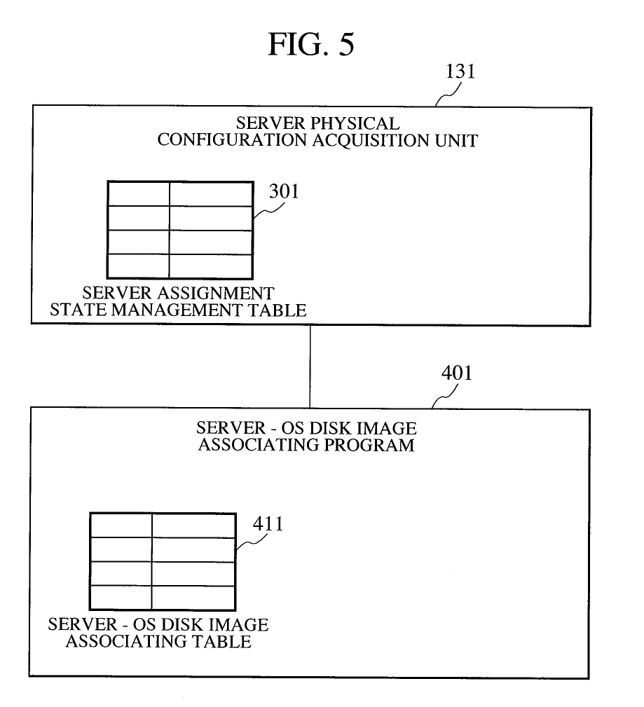

A relationship between the server physical configuration acquisition unit 131 and a server-OS disk image associating program is shown in FIG. 5. The server physical configuration acquisition unit 131 operates in coordination with the server-OS disk image associating program 401 existing in the external storage device 211. The server physical configuration acquisition unit 131 has the server assignment state management table 301.

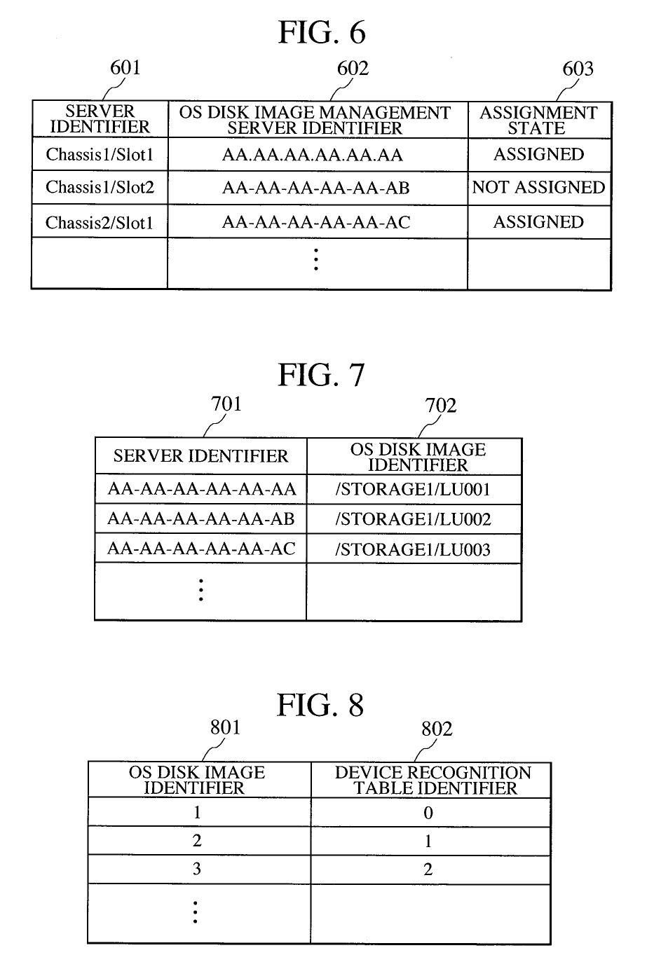

One example of a server assignment state management table 301 is shown in FIG. 6. Server identifiers 601, OS disk image management server identifiers 602, and assignment states 603 are stored as data items in mutually associated form in the server assignment state management table 301.

One server identifier 601 uniquely identifies one specific server 101 within the system, managed by the management server 130. A server of a blade system configuration, for example, is uniquely identified by a combination with an identifier identifying uniquely a chassis (enclosure) to which the server belongs. In another example, if servers to be managed are mounted on more than one rack in a system, each server can be uniquely identified by a combination of an ID (rack number) uniquely identifying the rack, and position information (in-rack ID) corresponding to mounting height of the server on the rack.

One OS disk image management server identifier 602 uniquely identifies one specific server within the system, managed by the management server 130. This identifier can be the same as the server identifier 601. Examples of OS disk image management server identifier 602 applicable for using an LU of a SAN storage device as the storage location for the OS disk image include a WWN (World-Wide Name) of a Host Bus Adaptor (HBA) connected to the server.

The server assignment state 603 denotes an operational state of the server. “Assigned” indicates that the server 101 under management is executing a task based on a certain OS disk image. “Not assigned” indicates that no OS disk image is assigned (the server 101 under management is not executing a task).

The server-OS disk image associating program 401 has a server-OS disk image associating table 411, an example of which is shown in FIG. 7. The server-OS disk image associating table 411 has two columns—an OS disk image management server identifier 701 and an OS disk image identifier 702. The OS disk image management server identifier 701 has the same contents as those of the OS disk image management server identifier 602 in the server assignment state management table 301. The server-OS disk image associating program 401 uses the OS disk image management server identifier 701 to manage a specific server 101 within the system. The OS disk image identifier 702 is an ID that uniquely identifies a specific OS disk image within the system. In the present embodiment, an LU present on an external SAN storage device is used as the storage location for an OS disk image, so two identifiers, for example, are combined. For example, one of them is an identifier for uniquely identifying a specific external SAN storage device and the other is an identifier for uniquely identifying an LU within the external SAN storage device. For example, a combination of identifiers for identifying an LU of LU No. 1 within STORAGE 1, a SAN storage device, is /STORAGE1/LU001.

The device recognition information table management unit 132 retains the OS disk image-device recognition information associating table 303 and the device recognition information tables 120 associated with individual OS disk images 111 in a 1:1 format.

The OS disk image-device recognition information associating table 303 manages data that defines a relationship between an OS disk image identifier and the device recognition information table 120 associated with the OS disk image. An example of composition of the OS disk image-device recognition information associating table 303 is shown in FIG. 8. The OS disk image-device recognition information associating table 303 itself is managed using the OS disk image identifier 801 and a device recognition table identifier 802 in a pair.

The device recognition information table 120 is a table used to store and update the device recognition information transmitted from an OS/device recognition information transmitting unit 140. The device recognition information table 120 will be described taking a PCI device as an example of a device of the server 101.

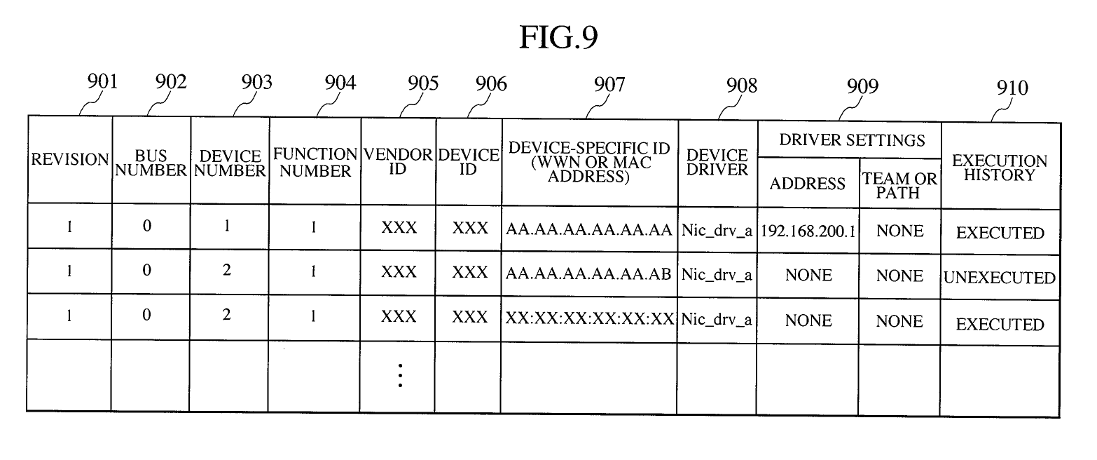

An example of composition of the device recognition information table 120 is shown in FIG. 9. The device recognition information table 120 is composed of a plurality of items, namely, a revision number 901, a bus number 902, a device number 903, a function number 904, a vendor ID 905, a device ID 906, a device-specific ID 907, a device driver 908, driver-associated settings 909, and an execution history 910.

The bus number 902, the device number 903, and the function number 904 are information that identifies a mounting location for the PCI device. The vendor ID 905 and the device ID 906 are respectively an identifier for a vendor who supplies the PCI device, and an identifier for the device. The device-specific ID 907 is an identifier for distinguishing uniquely the device from all other devices in the entire world. Devices such as NICs and HBAs have an identifier that uniquely identifies the device, such as a MAC address or a World-Wide Name (WWN). Since an OS may need to identify driver information by associating this information with such an identifier, the OS acquires and saves a specific ID for the corresponding product. The device driver 908 is an identifier for identifying a device driver program 505 used for the OS to operate the device. This identifier is usually a combination of a file name and version number, for example, of the device driver.

The driver-associated settings 909 are information settings associated with the device driver. These settings include parameters relating to the device driver, logical information associated with the driver, and other information. Examples of logical information include an IP address set for an NIC. Settings on teaming technology (this may also be termed bonding technology) that logically handles a plurality of NICs as one device are another example of logical information.

To acquire data items as the driver-associated settings, a person who mounts the OS/device recognition information transmitting unit 140 needs first to make a prior determination of the items required for the OS state determination unit 135 to determine a state of an OS to be supported, and then to program the acquisition of necessary items.

The execution history 910 is information that indicates whether the application has been actually executed in the past using the device driver settings 909. A state relating to the history, such as “Executed” or “Unexecuted”, is recorded. A more specific update example of the execution history 910 will be described later herein.

The device recognition information table management unit 132, as with the server physical configuration acquisition unit 131, identifies the OS disk image associated with a server in coordination with the server-OS disk image associating program 401, and stores the device recognition information acquired by the server physical configuration acquisition unit 131, into the associated device recognition information table 120.

During later operations, a person who administers the system changes the association between the server and the OS disk image, for purposes such as strengthening the server, changing its uses, or distributing a load in case of a scale-out event. At that time, the OS state determination unit 135 judges the OS for operability, by referring to the contents of the device recognition information table 120 and the device configuration information acquired by the server physical configuration examination unit 133 described below. The OS state determination unit 135 suppresses execution of the OS disk image if the OS cannot be executed on the server.

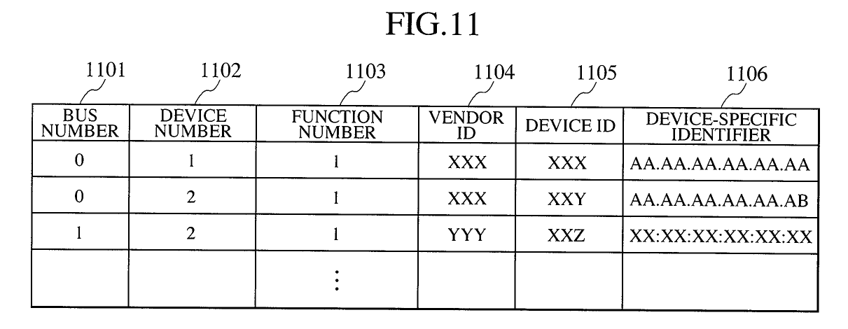

The server physical configuration examination unit 133 executes an examination OS on the server 101 and acquires physical device configuration information of the server. The server physical configuration examination unit 133 retains the examination OS image 302 on the management server 130. The examination OS is the OS disk image shown in FIG. 3, but since this OS has only functions required for device examination, the OS does not have an unnecessary program code and is small in program code size. The examination OS transmits a physical device configuration information send message to the server physical configuration examination unit 133. An example of composition of the physical device configuration information send message is shown in FIG. 11. The physical device configuration information send message is composed of a bus number 1101, a device number 1102, a function number 1103, a vendor ID 1104, a device ID 1105, and a device-specific identifier 1106. Each of these pieces of information is of the same kind of information as that of the bus number 902 to device-specific ID 907 retained in the device recognition information table 120. The device recognition information table 120 represents a device configuration of the OS disk image 111 that exists when the disk image is in operation. In contrast to this, the information contained in the physical device configuration information send message represents examination results on a current device configuration, so even if the server 101 under management is the same as the server for which the server physical configuration acquisition unit 131 acquired the device recognition information of the OS disk image, the configuration of the device differs, for example, if any of its hardware components has been replaced. In addition, the servers 101 specified by different server identifiers 601 are most likely to differ in device configuration. Each of these pieces of information is based on the information acquired using a required method and in a required format defined by PCI specifications or the like. Details of the acquisition are omitted.

The OS state estimation unit 134 receives the server identifier 601 shown in FIG. 6, and the OS disk image identifier 702 shown in FIG. 7, as inputs. The OS state estimation unit 134 also judges how each device is recognized when the OS disk image operates on the server 101. The judgment is conducted using the device recognition information table 120 associated with the OS disk image identifier 702, and the physical device configuration information send message (see FIG. 11) that the server physical configuration examination unit 133 has acquired from the server 101 indicated by the server identifier 601.

One example of mounting the OS state estimation unit is in the form of a program that simulates device driver program logic of the OS and returns device recognition information as simulation results. The system provider (usually, a person who mounts the management server system) mounts the OS state estimation unit 134 by programming. Under the presupposition that device-recognizing specifications of the OS are known, this program is a module that executes logically intact the same logic as the operational logic of the OS, and can be actually mounted.

Another example of a mounting form of the OS state estimation unit 134 is by providing a dedicated virtual server for device recognition estimation. In this method, the same virtual server OS as the OS disk image 111 is provided, then a device configuration of the virtual server is updated to the above-described device configuration information, and device recognition information of the OS on the virtual server is updated to the settings recorded in the device recognition information table 120. The OS can then be started on the virtual server. After the start, a program of the OS/device recognition information transmitting unit is executed on the OS of the virtual server, and after acquisition of the device recognition information, the driver-associated settings 909 contained in the device recognition information are returned as results.

The OS state determination unit 135 receives, as its inputs, the physical device configuration information send message (see FIG. 11) and the driver-associated settings 909 that the OS state estimation unit 134 has estimated for each device. The OS state determination unit 135 also judges whether the driver-associated settings 909 indicate normal operation of the OS. The OS state determination unit 135 refers to an OS state determination rule 304 and judges whether the OS operates properly. The OS state determination rule 304 defines parameters relating to the OS settings 909 required for normal OS operation, and is created by the administrator or the system provider beforehand. One example of mounting the OS state determination rule 304 is in the form of a program that judges whether the device driver-associated settings of the OS for each device driver are as set beforehand. For example, a check item of the “IP address associated with the NIC must be a required value” is an example of OS state determination rule 304.

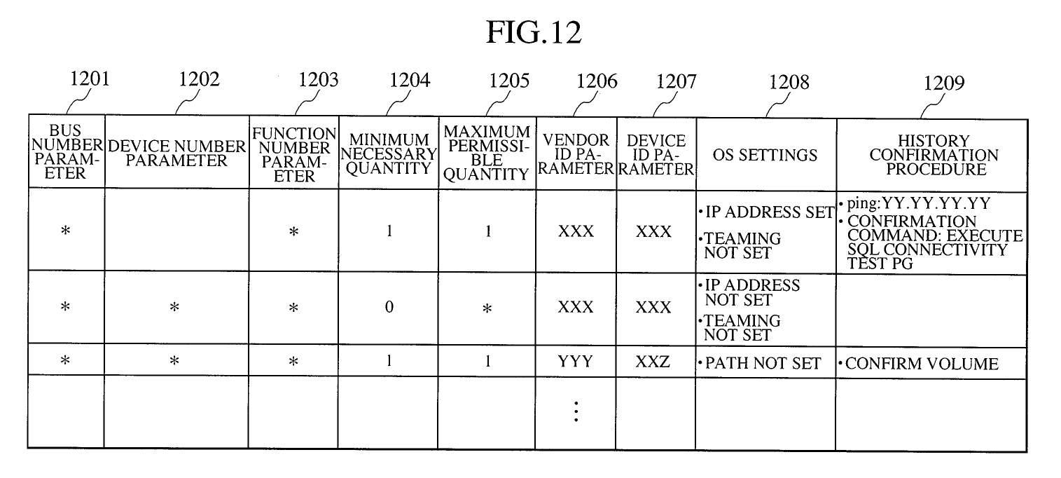

Another example of mounting the OS state determination rule 304 is by retaining the settings of normal operation of the device driver, as a table, instead of judging the state by a program code. When mounted as the table, the OS state determination rule 304 judges the OS to operate properly if the settings of the OS device driver, specified by the rule 304, and the driver-associated settings 909 of the estimation results by the OS state estimation unit 134 agree and at the same time, a predefined history confirmation procedure 1209 has come to a normal end. The predefinition is performed by the system administrator (or the like) using, for example, a method created during construction of the management system. One OS state determination rule 304 exists for one device recognition information table 120. This means that both are associated in a 1:1 format for the OS disk image. An example of composing the OS state determination rule 304 as a table, is shown in FIG. 12. The OS state determination rule 304 is composed of a bus number parameter 1201, a device number parameter 1202, a function number 1203, a minimum necessary quantity 1204, a maximum permissible quantity 1205, a vendor ID parameter 1206, a device ID parameter 1207, an OS settings 1208, and the history confirmation procedure 1209 mentioned above.

The section from the bus number parameter 1201 to the device ID parameter 1207 identifies a device to be subjected to parameter-based judgment. If the data in the section from the bus number 902 to device ID 906 in the device recognition information table 120 agrees with the parameters specified by the above-described bus number parameter 1201 to device ID parameter 1201, the corresponding device is subjected to the judgment. An example of setting the bus number parameter 1201 to function number parameter 1203 used to identify a position of a PCI device is by allowing a specific value, a given value, or relative order in a group to be designated. An example of the relative order is a parameter specifying the “nth smallest value of all device identification numbers of the same vendor ID and device ID.” Also, each parameter can contain more than one value, in which case, the OS state determination unit 135 judges the parameter to be satisfied when contents of the OS state determination rule 304 match any one of the values.

In addition, the number of devices that satisfies the above parameter needs to stay between values of the minimum necessary quantity 1204 and the maximum permissible quantity 1205.

The OS settings 1208 are a list of data of the OS settings 909 that is to be satisfied when the OS operates. For example, if the subject of the judgment based on the OS settings 1208 is an IP address, the usable parameter is, for example, “IP address is equal to XX.XX.XX.XX”, “settings of the IP address mean DHCP acquisition”, or “IP address is unset.” When the driver-associated settings 909 of the device determined as the subject of the judgment match the OS settings 1208, the OS is judged to operate.

The history confirmation procedure 1209 is information that denotes the procedure for confirming an operational history of an actual application. The history confirmation procedure includes the procedures laid down beforehand. These procedures are, for example, “Execute ping to YY.YY.YY.YY”, “Confirm connection to database YY using an SQL program”, or “Execute application connectivity test program A.” A specified procedure is executed in the OS operational history confirmation process flow described later herein. It is to be understood that a code returned as a result of normal end is predetermined for each program and that the fact that the program is working properly can be confirmed when a value of the code becomes a specific value.

Operational flows of individual programs of the management server 130 are described below.

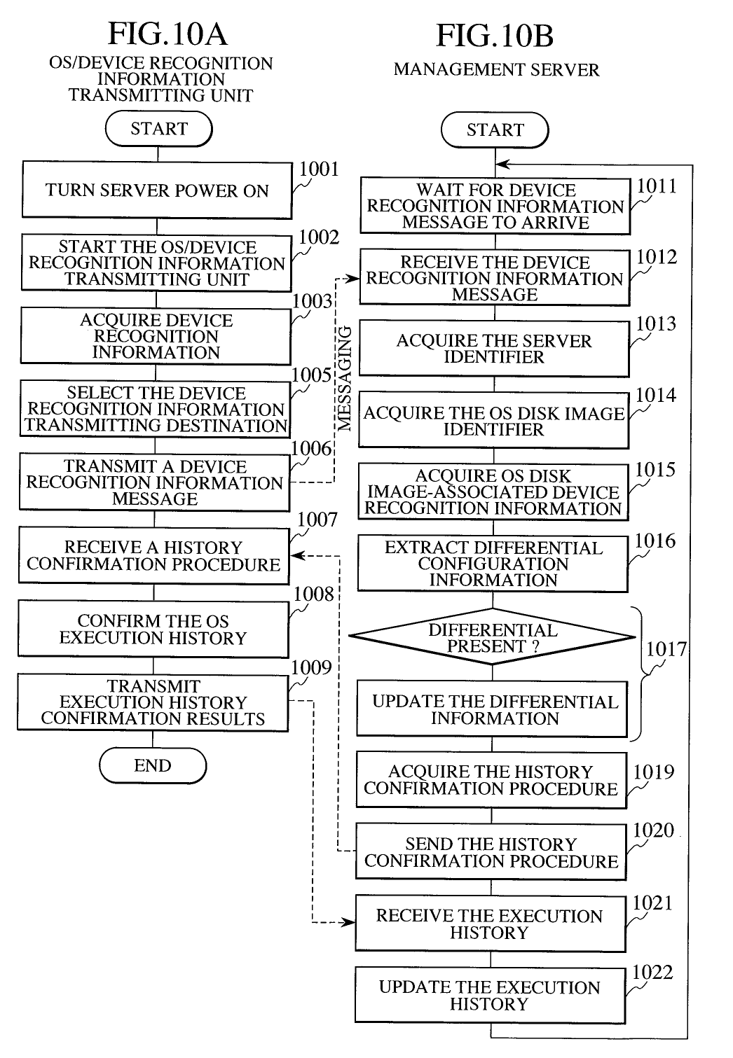

First, the operational flow of acquiring device recognition information is described using FIGS. 10A and 10B. The OS/device recognition information transmitting unit 140 that operates on the server 101 under management, and the server physical configuration acquisition unit 131 that operates on the management server 130 work together to acquire the device recognition information.

An example of an operational flow of the OS/device recognition information transmitting unit 140 is described below using FIG. 10A. First, a server to be managed is powered on (step 1001). This server power-on operation can be performed using any method. For example, the server can have its power supply button turned on in given timing by a person. Alternatively, the system administrator may use the user interface of the management server to specify the start of the server, or a power supply management program for the management server may start processing at a prescheduled time automatically. If the system administrator is to use the user interface to specify the start of the server, the system administrator is made, for example, to select a server identifier 601 and start the server to be managed. An example of mounting for making the system administrator select a server identifier 601 is by presenting the list of server identifiers 601, retained in the server assignment state management table 301 of the management server 130, to the administrator through the user interface of the management server to request the administrator to select one server identifier from the list.

The powered-on server 101 uses the boot loader program 501 to start the OS kernel program 502, thus making functionality of the OS operative. During the start of the OS, an OS/device recognition information transmitting program 508 starts operating (step 1002).

The OS/device recognition information transmitting program 508 acquires device driver recognition information 505 through an interface accessing the OS functionality (step 1003). The information acquired will relate to the items contained in the device recognition information table of FIG. 9, each of these items being acquired for all devices belonging to the physical server on which the OS operates.

The OS/device recognition information transmitting program 508 identifies a device recognition information transmitting destination (step 1005). The device recognition information transmitting destination must be the management server 130. An address of the management server, predefined on a setup file (or the like) of the examination OS by the system administrator, can be used as an example to identify the device recognition information transmitting destination.

A device recognition information message is sent to the device recognition information transmitting destination that was selected in step 1005. The OS/device recognition information transmitting program 508 can be mounted so as to transmit the device recognition information message to the management server through an interface such as an NIC.

In step 1007, the OS/device recognition information transmitting program 508 waits for the history confirmation procedure 1209 to be returned from the messaging destination in step 1006.

Upon receiving the history confirmation procedure 1209 from the management server, the OS/device recognition information transmitting program 508 confirms the history confirmation procedure 1209 in a way defined therein (step 1008). The history confirmation procedure is laid down in an independent confirmation program format or a format of a batch file defining a program execution sequence. The OS/device recognition information transmitting program 508 executes programs in sequence and acquires execution result information in the form of, for example, a termination code returned to the OS.

The OS/device recognition information transmitting program 508 terminates processing (step 1009) by transmitting execution results on the history confirmation procedure which was acquired in step 1008, to the device information transmitting destination that was selected in step 1005.

An example of the operation flow in the management server 130 which acquires and stores data is shown in FIG. 10B.

The management server 130 waits for a device recognition information message (step 1011). This waiting step is programmable to be executed in the same manner as that of normal NIC-based message receiving by the network program.

In step 1012, the server physical configuration acquisition unit 131 receives the device recognition information message transmitted in step 1006.

The server identifier 701 shown in FIG. 7 is acquired from the information contained in the device recognition information message (step 1013). For example, if the OS disk image is an LU, when the vendor ID 905 and the device ID 906 indicate an HBA product, the device-specific ID 907 is viewed and the information indicating the WWN of the HBA is extracted for use as the server identifier 701.

The server physical configuration acquisition unit 131 delivers the server identifier 701 to the device recognition information table management unit 132, thereby requesting the management unit 132 to acquire the list of OS/device recognition information tables used for the server identifier 701. In step 1014, the device recognition information table management unit 132 coordinates with the server-OS disk image associating program 401 to view the server-OS disk image associating table shown in FIG. 7, and acquires the OS disk image identifier 702 associated with the server identifier. In step 1015, the device recognition information table management unit 132 views the OS disk image-device recognition information associating table shown in FIG. 8, and after acquiring the device recognition information table associated with the OS disk image identifier 702, returns the data within the particular table to the server physical configuration acquisition unit 131.

In step 1016, the server physical configuration acquisition unit 131 compares the device recognition information message acquired in step 1012, and each item in the device recognition information table acquired in step 1015, and extracts differential information. Two kinds of differentials can exist: (a) items concerning the devices for which the same bus number 902, device number 903, function number 904, vendor ID 905, and/or device ID 906 exist in the device recognition information message, but do not exist in the device recognition information table, and (b) items concerning the devices for which information exists in both the device recognition information message and the device recognition information table, but differs in associated device driver 908 or in driver-associated settings 909.

The above extraction can be conducted by comparing the bus numbers 902 to device driver-associated settings 909 of the corresponding devices and confirming whether the information falls under above item (a) or (b).

If any differentials are found in step 1016, the differential information is updated to the device recognition information table contents (step 1017). Any updates on item (a) mean item additions, and any updates on item (b) mean item overwriting.

In step 1018, the server physical configuration acquisition unit 131 views the OS state determination rule 304 associated with the device recognition information table acquired in step 1015, and acquires all history confirmation procedures 1209 included in the table.

In step 1019, the server physical configuration acquisition unit 131 transmits the list of history confirmation procedures 1209 acquired in step 1018, to the OS/device recognition information transmitting program 508 that sent the device recognition information message in step 1012. For example, execution results are transmitted in such a format as of a table having two pieces or two sets of information in a pair, so as to allow the executed programs and the execution results to be confirmed in a pair.

Finally, the server physical configuration acquisition unit 131 waits in step 1020 for the OS/device recognition information transmitting unit to execute the history confirmation procedures 1209 that were sent thereto in step 1019, and then return execution results. Upon receiving the results, the server physical configuration acquisition unit 131 confirms whether each result indicates a normal end. In step 1021, the server physical configuration acquisition unit 131 writes “Executed” into each associated execution history 910 if the result is a normal return value, or “Unexecuted if the result is an incorrect return value.

Information on device recognition by the OS, and execution result information are acquired into the management server 130 during processing shown in FIG. 10. The two kinds of information are later used as input information for judging the OS for normal operation when the association between the OS disk image 111 and the server 101 is changed.

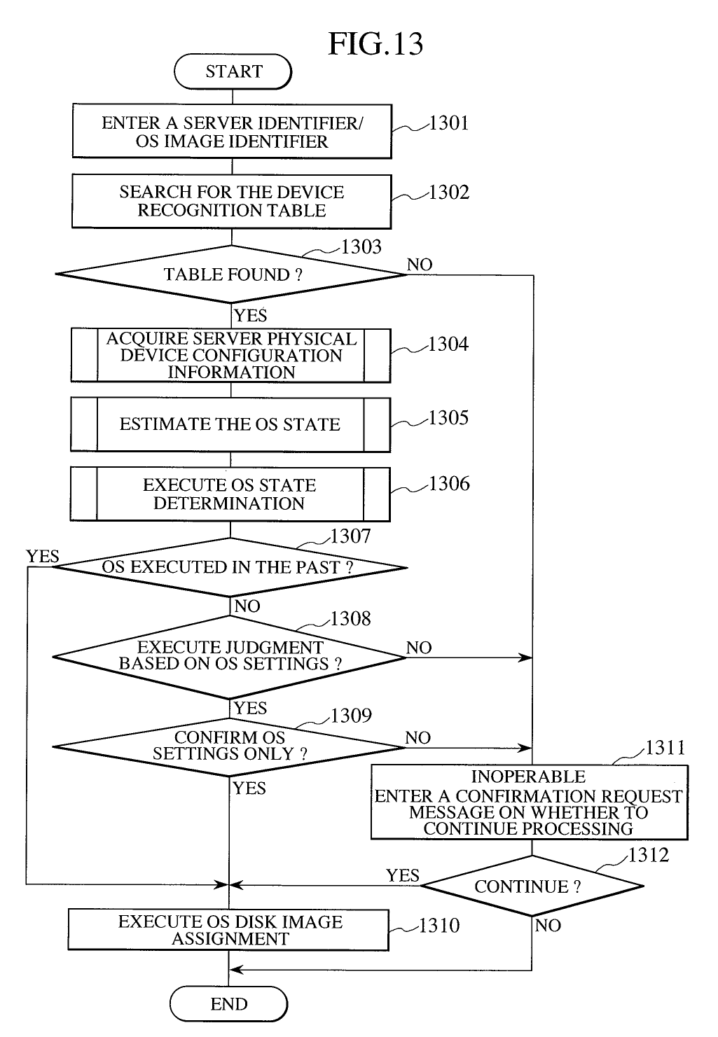

When the current server 101 associated with the OS disk image 111 is changed to another server 101 by the administrator, the judgment for normal OS operation on the new server 101 will be conducted using the OS disk image 111. The operation flow of the judgment process is described below using FIG. 13.

The management server 130 accepts input of a server identifier 601 and that of an OS disk image identifier 702 (step 1301). The useable methods of input to the two items include server specification by the system administrator using, for example, the user interface of the management server. If the system administrator is to specify the desired server using the user interface, the list of server identifiers 601, retained in the management server 130, may be presented to the administrator through the user interface of the management server so that the administrator can select one server identifier from the list, and the OS disk image associated with this server identifier.

In step 1302, the management server 130 refers to the OS disk image identifier 702 that was input in step 1301, and acquires the associated device recognition information table 120. The acquisition can use a method equivalent to that set forth in the description of step 1015.

Steps 1304 to 1310 will be executed when the associated device recognition information table 120 is found in step 1302. Steps 1311 and 1312 will follow step 1303 if the associated table is not found.

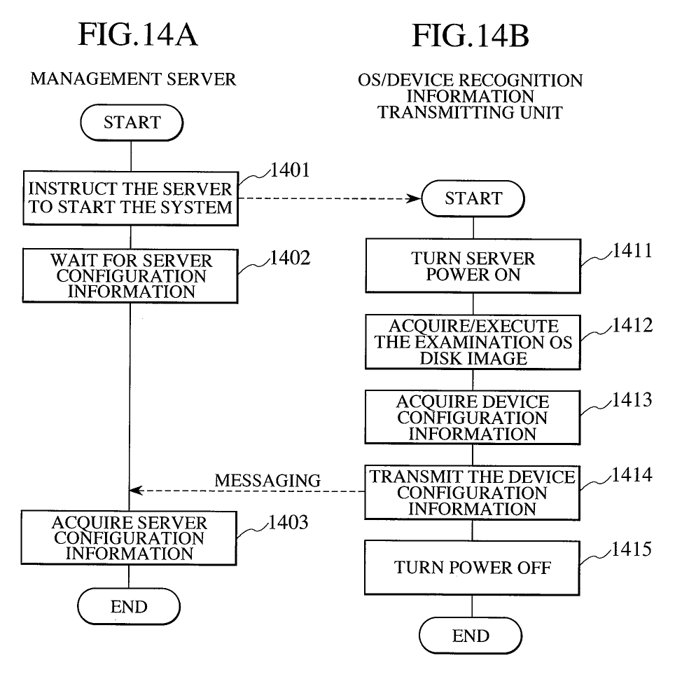

The management server 130 delivers the server identifier 601 that was acquired in step 1301, to the server physical configuration examination unit 133 and calls for server physical configuration information. In step 1304, the server physical configuration examination unit 133 executes the procedure (device configuration information acquisition from the physical server) shown in FIG. 14, and responds with a device configuration information message to the management server. A more specific example of the acquisition process will be described later herein.

The management server 130 delivers the device recognition information table 120 that was acquired in step 1302, and the device configuration information message that was acquired in step 1304, to the OS state estimation unit 134, thus requesting the OS state estimation unit 134 to return the device driver recognition information table of the input-information-based device recognition results by the OS. The OS state estimation unit 134 executes the foregoing emulation process and the like, and returns the device recognition information table of the OS as execution results (step 1305).

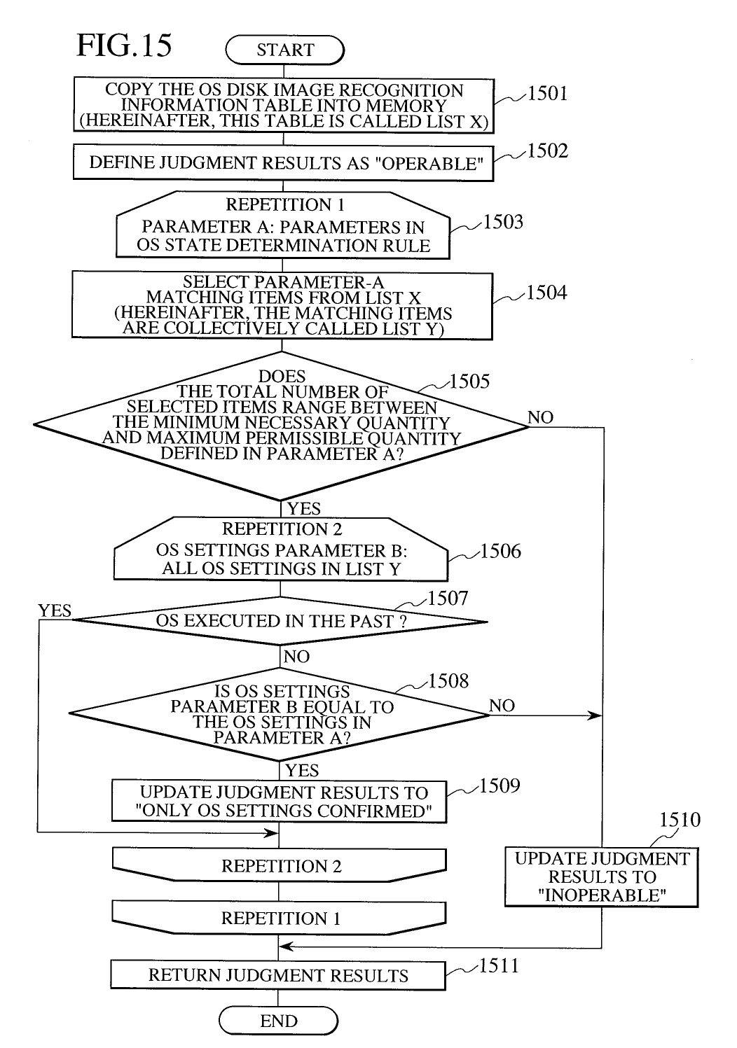

The management server 130, by delivering to the OS state determination unit 135 the device recognition information table that was acquired as execution results in step 1305, requests the determination unit to judge whether the OS specified by the OS disk image identifier 702 operates properly on the server 101 specified by the server identifier 601. In step 1306, the OS state determination unit 135 executes the procedure shown in FIG. 15, and returns OS state determination results.

Step 1310 is executed if the judgment results in step 1306 are “OS executed in the past”. Step 1308 follows step 1307 if the OS is judged not to operate.

It is confirmed whether an operational state estimation based on the OS settings is to be conducted. Several methods are usable for the confirmation. One method is by, for example, providing beforehand a flag that indicates whether the state estimation based on the OS settings is to be conducted, and requesting the administrator, during building of the management system, to select whether to conduct the estimation. Another method is by, for example, displaying a dialog message saying “Confirmation of execution history has failed. Do you wish to conduct a state estimation based on the OS settings? (Y/N)” through the user interface and requesting a response to the inquiry message. Step 1308 is followed by steps 1309 and 1310 if the response obtained is positive, or steps 1311 and 1312 if the response is negative.

Step 1310 is executed, provided that the judgment results in step 1306 are “Only OS settings confirmed” and that the response to the inquiry in step 1308 as to whether to conduct the state estimation based on the OS settings is positive. If either of the two conditions is not satisfied, steps 1311 and 1312 follow step 1309.

If, in step 1306, the OS is judged to have already been executed to normal completion in the past, if the judgment results in step 1309 are “OS settings confirmed”, or if an instruction to change the association between the OS disk image 111 and the server 101 is given in step 1311 as described later herein, then step 1310 is executed to conduct the change of the association between the OS disk image 120 and the server 111. If the OS disk image 120 is mounted as the LU existing on a SAN storage device, the change of the association is accomplished by instructing the path management program 401 to change the server-OS disk image associating table and then changing the association between the LU and the WWN of the server identifier 701 through, for example, setting SAN storage device and SAN network setup information.

If the judgment results indicating that the OS properly operates are not obtained, the management server 130 notifies this fact to the administrator (or the like) who performs the association-changing operations, and requests the administrator to confirm whether the operations are to be continued (step 1311). The methods usable for the notification and for the inquiry about confirmation include one in which, for example, a dialog message saying “Specified server has not been executed before. Do you wish to continue the association change? (Y/N)” is displayed through the user interface. The administrator responds with “Yes” or “No.”

If “Yes” is entered in step 1311, step 1310 is executed. If “No” is entered in step 1311, then the process is terminated (step 1312).

In the above operation flow, when the administrator, for example, attempts changing the association between the OS disk image 111 and the server 101, even if, in the combination of the OS disk image 120 and the server 101, the OS does not operate properly during the recognition of the device or the assignment of logical settings or at one specific task level, that fact can be detected beforehand and notified to the administrator. Originally non-intended latent malfunctioning of the OS due to reasons such as a mistake in the administrator's operations or part replacement of the physical server can be prevented as a result.

One example of the device configuration information examination flow which was referred to in step 1304 of FIG. 13 is described below using FIGS. 14A and 14B.

The device configuration information examination flow is executed by mutual operation of the management server 130 and the server 101.

The management server 130 instructs the server 101 to start the system using the examination OS disk image 302 (step 1401). The server 101, upon receiving the management server instruction, turns power on (step 1411) and then acquires and executes the examination OS disk image 302 (step 1412). Steps 1401, 1411, 1412 can be implemented by, for example, combining Wake-on-Lan and PXE boot. The management server 130 and the server 101 intercommunicate through an NIC. The server 101 has an NIC associated with Wake-on-Lan, and turns power on after receiving specific packets sent from the management server 130. The management server 130 has server functions supported for PXE boot, and delivers the examination OS disk image to the server 101. The server 101 has client functions supported for PXE boot, and acquires and executes the examination OS disk image.

After being started, the examination OS acquires the device configuration of the server 101 (step 1413). FIG. 11 shows an example of a server device configuration. In a PCI device, for example, since the PCI bus number 1101 to device ID 1105 are written into predetermined positions of the memory, the PCI device can be mounted by reading the memory contents, for example.

The examination OS reshapes the device configuration information that was acquired in step 1413, into a format of the physical device configuration information send message shown in FIG. 11, and transmits the message to the management server 130 (step 1414). After this, the server 101 is powered off (step 1415).

The management server 130 acquires the physical device configuration information send message that was transmitted in step 1414, and delivers the message to the component that requested the process (step 1403).

Finally, one example of the OS state determination execution flow which was referred to in step 1306 of FIG. 13 is described below using FIG. 15.

The OS state determination unit 135 receives, as inputs from other components, the physical device configuration information send message of FIG. 11 and the OS/device recognition information table (shown in FIG. 9) that is the OS state estimation results by the OS state estimation unit 134, and judges the OS for normal operation by referring to the two kinds of information. Hereinafter, the OS/device recognition information table is called list X (step 1501).

A saving region for storage of OS state determination results during subsequent processing is simply called the determination results. The determination results can be a saving region reserved in the memory or the like. An initial value of the determination results is defined as “Operable” (step 1502).

The OS state determination unit 135 repeatedly executes steps 1503 to 1506, for each parameter of the OS state determination rule in FIG. 12 (step 1503). Hereinafter, the items that have been selected in this step are collectively called parameter A.

The OS state determination unit 135 selects, from the devices contained in list X, only those matching the parameter A in accordance with the foregoing rules in the description of FIG. 12 (step 1504). Hereinafter, the devices that have been selected in this step are collectively called list Y. If the selected number of devices stays within a range indicated by the minimum necessary quantity 1204 and maximum permissible quantity 1205 in FIG. 12, steps 1505 to 1507 are executed (step 1505). Step 1510 is executed if the selected number falls outside the above range.

After the execution of step 1506, steps 1507 to 1509 are executed for the device driver information (hereinafter, termed device driver information B) associated with each device selected in step 1504.

It is confirmed whether the state of the execution history contained in device driver information B is “OS executed in the past.” If so, control is transferred to processing of the next device driver information contained in list Y (step 1507).

It is confirmed whether device driver information B matches the OS settings 1208 contained in parameter A. The confirmation uses the method shown in the description of the OS settings 1208 of FIG. 12. The OS settings 1208 may include a plurality of items relating to teaming and IP addressing. If that is the case, the above confirmation is conducted for each item independently (step 1508).

If the item is judged to mismatch, step 1510 is executed. If the item is judged to match, previous judgment results are updated to “Only OS settings confirmed” (step 1509).

If the OS has not been executed before and parameter B of the OS settings is not equal to parameter A thereof, the judgment results are updated to “Inoperable” and step 1511 is executed (step 1510).

A final update of the judgment results in either of the above process steps is returned to other components as the judgment results based on the OS state determination unit (step 1511).

### Second Embodiment

When the administrator changes the association between an OS disk image 111 and a server 101 to be managed, the administrator usually intends first to select hardware on which the business application is to be executed, from a plurality of candidates present in the system. Since the business application is contained in one specific OS disk image 111, it is common for choices to be naturally narrowed down to one. As a result, when the administrator changes the association between an OS disk image 111 and a server 101, the administrator needs to execute two steps, namely, (a) selecting the OS disk image 111 and (b) searching for a server 101 on which the OS disk image 111 operates properly, in that order.

The first embodiment has related to judging whether the OS operates properly in the specified combination of the server and OS disk image specified by the administrator. In the method of the first embodiment, to identify from the plurality of servers within the system only the servers on which the OS disk image operates properly, the administrator must confirm normal OS operation on each server independently.

In order to reduce such a confirmation work load upon the administrator, a second embodiment presents thereto a list only of servers for which the normal operation of an OS has been confirmed, and makes the administrator or the like select an appropriate server from the presented server list.

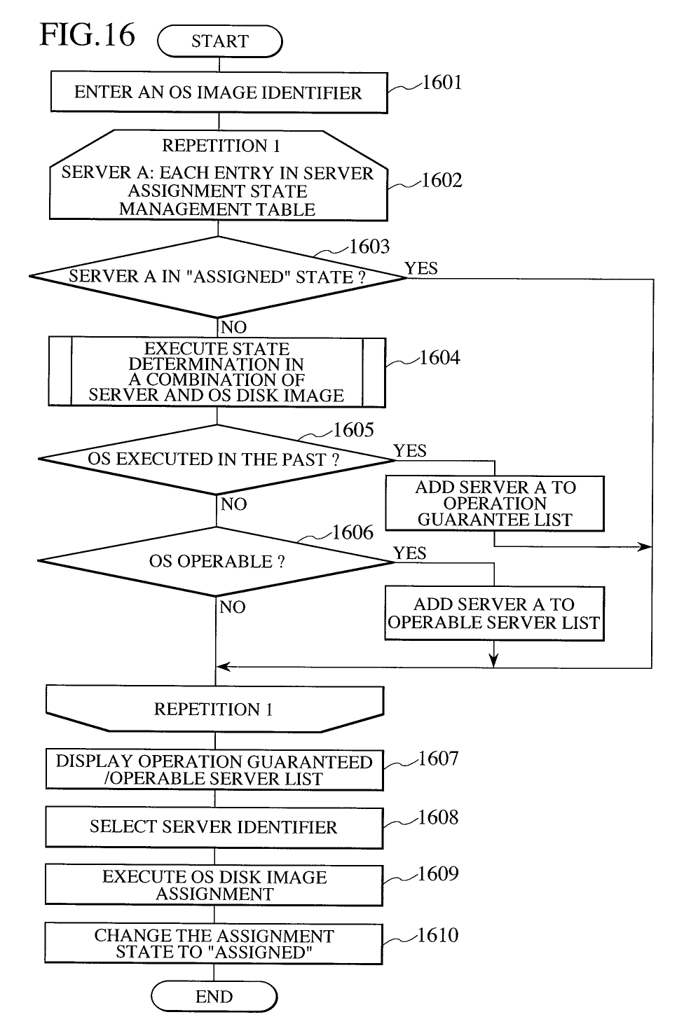

The second embodiment assumes essentially the same system configuration as that of the first embodiment, except that whereas the administrator or any other operator in the first embodiment who associates a server and an OS disk image has performed the association change in accordance with the operation flow in FIG. 13, the association change in the second embodiment is conducted in accordance with the state determination process flow in the server-OS disk image combination of FIG. 16.

First, the management server 130 receives in step 1601 an OS disk image identifier 702 as input information in essentially the same way as used in step 1301. At this time, the management server 130 does not need to receive a server identifier 601 as input information.

Next, steps 1603 to 1606 are executed for each server listed in the server assignment state management table 301 (step 1602). Hereinafter, the listed servers are each termed server A. Also, an operationally guaranteed server list and an operable server list are used during subsequent processing, these lists being data of a list format, intended to record the servers whose normal operation has been confirmed. In addition, subsequent processing assumes that the lists are cleared before a repetitive process is executed in step 1602 following completion of step 1601. The lists can be saved in the memory.

It is confirmed whether “Assigned” is recorded as the server assignment state 603 associated with each server A listed in the server assignment state management table 301. If “Assigned” is not recorded, steps 1604 to 1606 are executed (step 1603).

In step 1604, steps 1302 to 1309 of FIG. 13 are executed using the server identifier 601 of server A and the OS disk image identifier that was input in step 1601. In step 1307, however, alternatively to the process of requesting confirmation by displaying “Inoperable” through the user interface, judgment results of “Inoperable” are recorded and steps 1605 and 1606 are executed.

If execution results of step 1604 are “OS executed in the past”, server A is added to the operationally guaranteed server list (step 1605).

If execution results of step 1604 are “OS operable”, server A is added to the operable server list (step 1606).

After executing steps 1602 to 1606 for all servers A within the server assignment state management table 301, the management server 130 presents to the operator a list of servers included in the operationally guaranteed server list and the operable server list, through the user interface (step 1607). At this time, each server is displayed in such a way that whether the server is included in the operationally guaranteed server list or the operable server list can be determined. In an example of server display, each listed server may be assigned a specific icon different between the operationally guaranteed server list and the operable server list.

In step 1608, the operator selects one of the servers listed in step 1607.

Through essentially the same process step as step 1309 of FIG. 13, the management server 130 changes the association between the server 101 and the OS disk image 111 (step 1609).

In the server assignment state management table, the assignment state of the entry associated with the server identifier selected in step 1608 is changed to “Assigned” (step 1610).

The above operation eliminates the need for the administrator to try the operational determination of the OS disk image 111 for all servers. The above operation also allows the administrator to select any of the operationally guaranteed servers and to enhance working efficiency. In addition, whether the normal operation of the OS has been guaranteed in the past and whether the operation has been guaranteed at a level that allows estimation of a logically operable state can be easily confirmed by comparison. When a server to be associated with the OS disk image 111 is selected from a plurality of candidates, therefore, the present embodiment offers a beneficial support effect in the operator's judgment for the selection.

### Third Embodiment

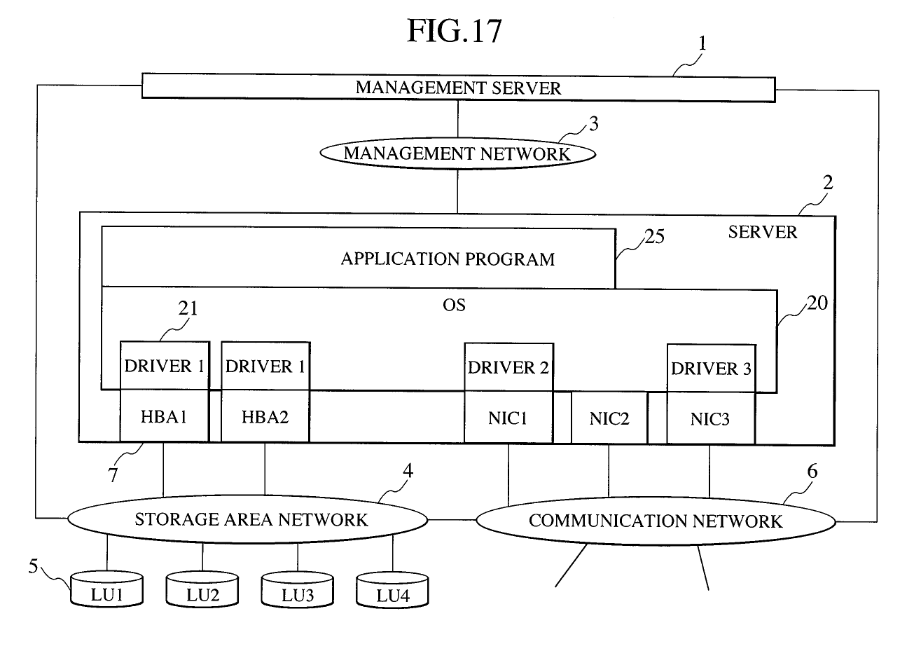

FIG. 17 is a block diagram of a system according to a third embodiment. The management server and the servers to be managed are each assigned a new reference number since details differ from those of the two types of servers in the first embodiment. Not all differences in reference number signify any differences between the corresponding servers.

A management server 1 connects to a server 2 to be managed, via a management network 3. While one server is shown as the server 2 to be managed, an actual number of servers to be managed can be more than one. The management server 1 and the server 2 connect to a storage area network (SAN) 4 so that both can access an LU 5 of a storage device. The management server 1 and the server 2 also connect to a communication network 6 to communicate with other servers. Although the management server 1 communicates with the server 2 during an actual communication session, the communication party for the server 2 may be another server 2 to be managed, or may be a server excluded from management, or a client computer serviced by the server 2.

The server 2 has HBAs as I/O devices 7 for connection to the SAN 4, and NICs as other I/O devices 7 for connection to the communication network 6. In FIG. 17, HBA 1 and HBA 2 are shown as the HBAs, and NIC 1, NIC 2, and NIC 3, as the NICs.

FIG. 17 shows a state in which the OS disk image described in the first embodiment is loaded within the server 2. As described in the first embodiment, the OS disk image includes an OS 20, I/O drivers (I/O device drivers) 21, and an application program 25. In FIG. 17, the I/O drivers 21 are shown as part of the OS 20, and are each associated with a specific I/O device 7. Although the NIC 2 is provided on the server 2, FIG. 17 indicates that the NIC 2 is not being used under a current state of the OS disk image. The I/O drivers 21 associated with the HBA 1 and HBA 2 are both “drivers 1”. This indicates that both the HBA 1 and the HBA 2 are activated by the “drivers 1” of the same type of driver 21. However, since the setup information described in the first embodiment differs between the HBAs 1 and 2, an independent I/O device driver program including the setup information may be provided for each HBA. Alternatively, AN independent set of setup information may be provided for each HBA and the program may be shared.

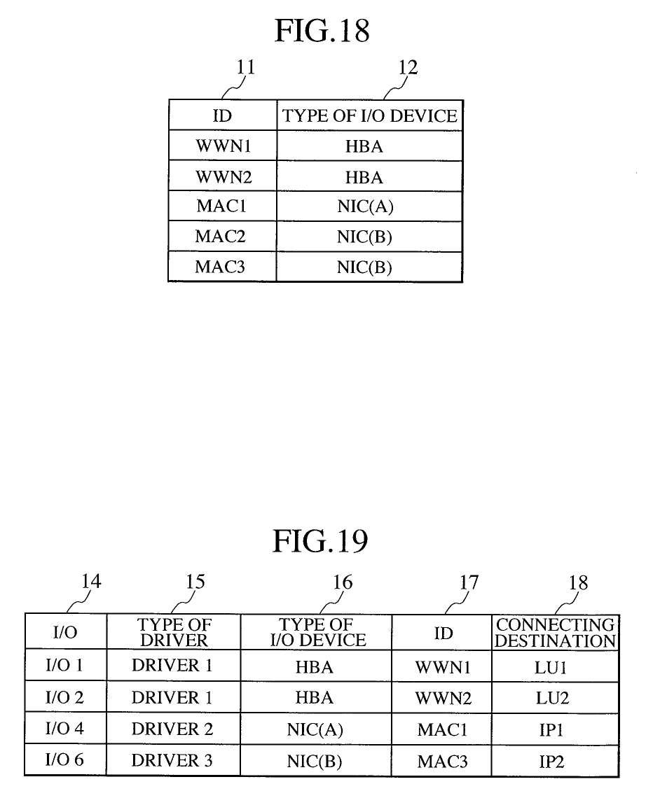

FIG. 18 shows an I/O device configuration table that the management server 1 provides. In the I/O device configuration table, IDs 11 of the I/O devices 7 which the server 2 has, and I/O device types 12 of each I/O device 7 are each stored in mutually associated form. While the IDs 11 and the I/O device types 12 are shown as typical items in FIG. 18 to offer a simplified description for ease in understanding, the I/O device configuration table may include the vendor IDs shown in FIG. 9, or other information specific to hardware such as the I/O devices 7. Contents of the I/O device configuration table are determined as specifications during building (installation) of the server 2, and the table is initially set via a user interface of the management server 1. Even after an operational start of the server 2, although the I/O devices 7 may also be subject to a configuration change due to a specifications change, the table will be set similarly to initial setting. Even after the configuration of the I/O devices 7 has been changed, however, settings of the I/O device configuration table may still remain unchanged. A process for acquiring the I/O device configuration is therefore provided to allow for such a case.

FIG. 18 is keyed to the configuration of the I/O devices 7 which the server 2 has. The HBA 1 and HBA 2 in FIG. 17 are of the same I/O device type, with the respective IDs 11 being WWN 1 and WWN 2. The NICs are divided into NIC (A) and NIC (B) as the I/O device types 12, with the ID 11 of NIC (A) being MAC 1 and the IDs 11 of NIC (B) being MAC 2 and MAC 3.

FIG. 19 shows an I/O device recognition table provided for the management server 1 to manage information relating to the I/O devices 7 recognized (used) by the current OS disk image on the server 2. Whereas the I/O device configuration table in FIG. 18 is provided in associated form with respect to the server 2, the I/O device recognition table in FIG. 19 is provided in associated form with respect to the OS disk image.

The I/O device recognition table has five columns, namely, I/O number 14, driver type 15, I/O device type 16, I/O device ID 17, and I/O device connection destination 18. The I/O number 14 is a logical name used for the application program 25 to access an I/O device 7, or an identifier of the I/O device 7. Upon issuance of an input/output command or send/receive command for access from the application program 25 to an I/O device 7, the OS 20 executes the I/O device driver program of the associated driver type 15 to operate the I/O device of the associated I/O device type 16 and ID 17, and executes a process based on the command, with respect to the party shown under the connection destination 18. As can be seen from the above description of the I/O device recognition table for the server 2, this table has the same contents as those set in the OS disk image. During creation of the OS disk image, therefore, the I/O device recognition table is initially set in accordance with specifications of the OS disk image via the user interface of the management server 1. Even after an operational start of the OS disk image, although the configuration of the I/O devices 7 and/or the specifications of the OS disk image may also be subject to change due to a system specifications change, the I/O device recognition table will be set similarly to initial setting. Even after the configuration of the I/O devices 7 has been changed, however, settings of the I/O device recognition table may not always be changeable since this table is associated with the OS disk image. In order to allow for such a case, therefore, a process for keying the settings of the I/O device recognition table to the configuration of the I/O devices 7 is provided or if the keying process is not mountable, a process for making the OS disk image itself inexecutable on the server 2 is provided instead. These processes will be described later herein.

The I/O device recognition table in FIG. 19 is keyed to the configuration of the I/O devices 7 applicable to the OS disk image on the server 2 of FIG. 17. More specific table contents will be described later in examples of operation of the management server 1 using the I/O device recognition table.

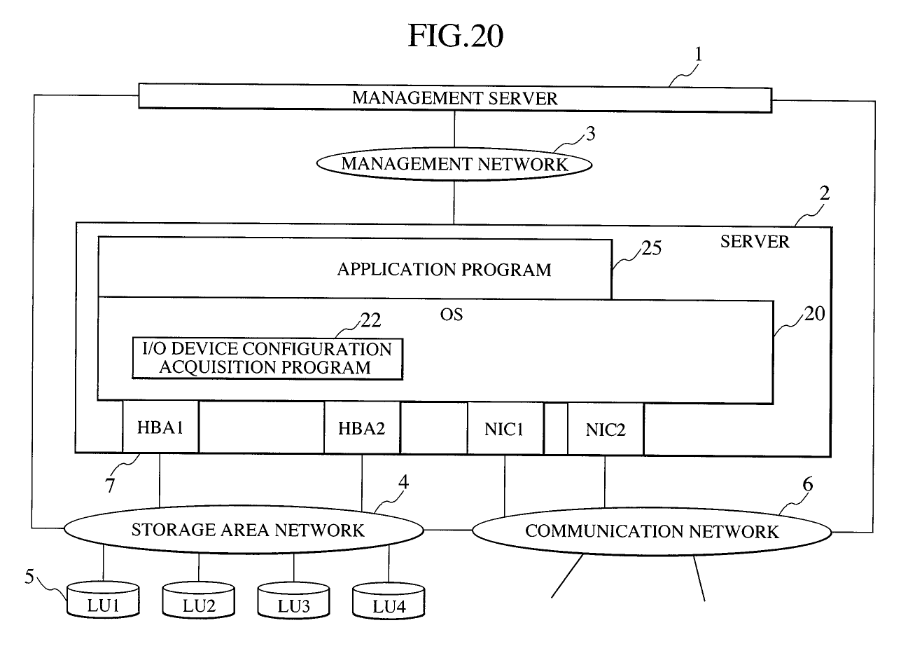

FIG. 20 shows a system configuration that includes another server 2 that is about to load and execute the OS disk image shown in FIG. 17, or includes the server 2 that was executing the OS disk image of FIG. 17. The latter case assumes that a time has elapsed since the state of the server 2 shown in the configuration diagram of FIG. 17. The I/O device configuration shown in FIG. 20 has already changed from that of FIG. 17 in two respects. One is a change in mounting position (location) of the HBA 2 in the server 2, and the other is that the NIC 3 is absent. Because of these changes, even when the OS disk image including the application program 25 shown in FIG. 17 is properly loaded and executed, it is likely that attempting access to the NIC 3 will result in an error and that attempting access to the HBA 2 will also result in an error.

As described above, the I/O device configuration table that the management server 1 has may not be keyed to the I/O device configuration shown in FIG. 20.

Accordingly, the OS disk image including an I/O device configuration acquisition program 22 is loaded into the server 2 and executed. This OS disk image is equivalent to the examination OS image shown in FIG. 4, and has an I/O device driver program appropriate for the device types of the I/O devices mounted in the server 2 placed under the management of the management server 1.

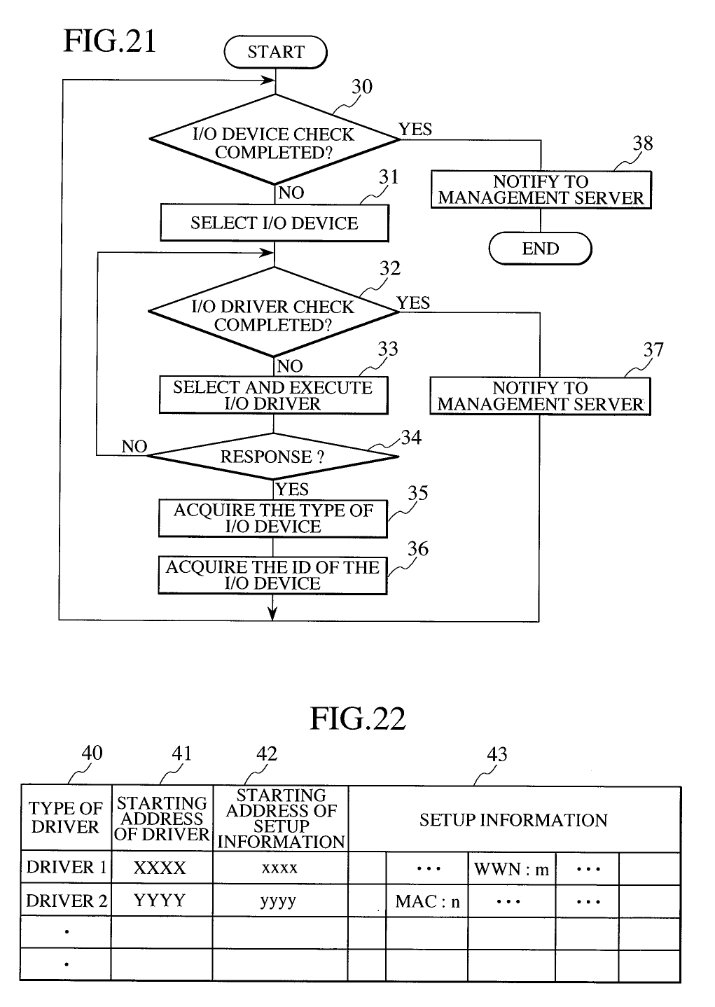

FIG. 21 shows a process flowchart of the I/O device configuration acquisition program 22. The I/O devices mounted in the server 2 are checked in sequence (step S30). An unchecked I/O device is selected (step S31). The operation of the I/O device driver programs is checked in sequence to find the driver type appropriate for the selected I/O device (step S32). An unchecked I/O device driver program is selected and executed (step S33). Selection of the I/O device driver programs uses a driver management table that the OS 20 has.

FIG. 22 shows the driver management table. The driver management table includes four columns, namely, a driver type 40, a driver starting address 41, a setup information starting address 42, and setup information 43. The driver type 40, the driver starting address 41, and the setup information starting address 42 are set during the creation of the OS disk image. The I/O device driver programs of the driver types 40 in the driver management table, therefore, are selected sequentially in order of listing. Execution of each selected I/O device driver program is started from a first address (starting address) shown under the column of the driver starting address 41 for the I/O device driver program. During the start of execution, the I/O device configuration acquisition program 22 delivers parameters to the I/O device so that this I/O device reads the I/O device setup information set as firmware. If the I/O device driver program matches the I/O device, the setup information will be read properly, but if the driver program does not match, an error response or no response will be obtained from the I/O device (time-out error). The setup information that has been properly read is stored into a setup information area starting from the setup information starting address 42. As shown under the column of setup information 43, the setup information area is separated into the setup information and a capacity (number of bytes) thereof, from left to right in order. The table in FIG. 22 indicates that for the driver 1, the setup information is stored from location “xxxx” of the setup information starting address 42 and that WWN is further stored in “m” bytes in the setup information.

Referring back to FIG. 21, if a response from the I/O device driver program is an error response, control is returned to step S32 for selection of another I/O device driver program. If no I/O device driver program matches, this is stored in I/O device associated form into a memory (step S37). If the response from the I/O device driver program is a normal response, the setup information starting address 42 and the setup information 43 are referred to and after the I/O device type has been acquired (step S35), the I/O device ID is acquired. Upon completion of checking of all I/O devices mounted in the server 2, the acquired I/O device types and I/O device IDs are transmitted to the management server 1 via the management network 3 (step S38). If the stored I/O devices include ones for which the appropriate I/O device driver program does not exist in step S37, the stored information is also transmitted in step S38.

In general, the interface specifications of I/O device driver programs are released to the public as the specifications of I/O devices from the vendors of the I/O devices. While the identification of an I/O device that uses an I/O device driver grogram has been described, therefore, if the address of the firmware (ROM) retaining the setup information is already made open, the I/O device configuration acquisition program 22 may directly read the setup information.

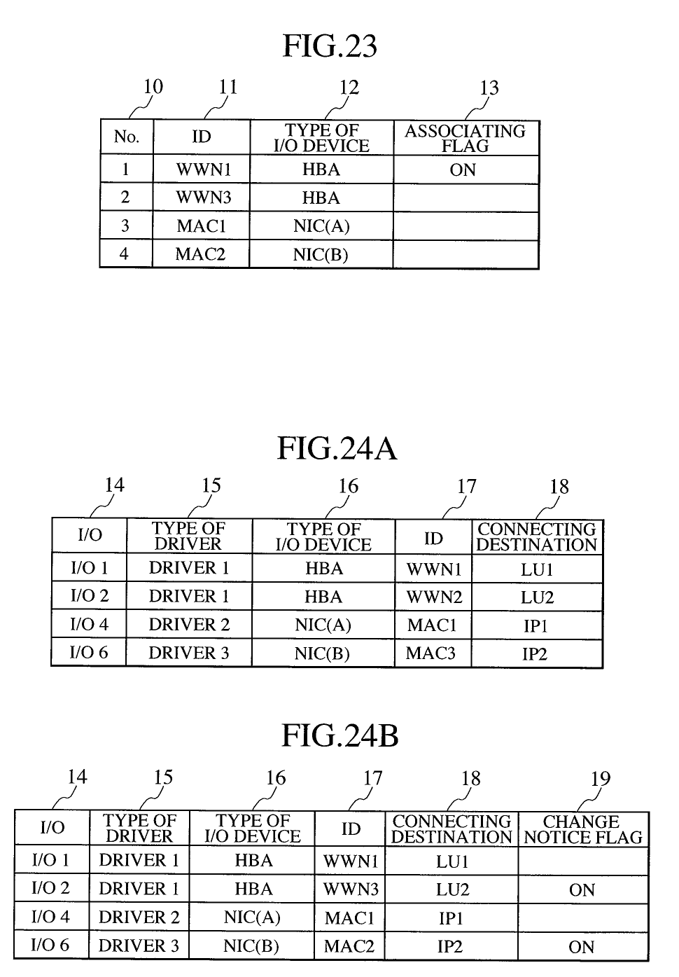

Upon receiving the I/O device types and the I/O device IDs from the server 2, the management server 1 updates the I/O device configuration table, as shown in FIG. 23. In addition to the I/O device configuration table items in FIG. 18, a “No.” (number) column 10 and an associating flag column 13 are provided in FIG. 23. The associating flag column 13 will be described later. FIG. 23, which shows the configuration of the I/O devices mounted in the server 2 of FIG. 20, indicates that No. 1, No. 3, and No. 4 I/O devices are of the same configuration as in FIG. 17 and that a No. 2 I/O device differs in ID. FIG. 23 also indicates that the I/O device whose ID is shown as MAC 3 under the I/O device ID column 11 in FIG. 18 does not exist.

The management server 1 copies into a work area the I/O device recognition table shown in FIG. 19, that is, the I/O device recognition table associated with the OS disk image which the server 2 is going to execute. FIG. 24A shows the copied I/O device recognition table. A change notice flag column 19 is added to the copied I/O device recognition table, as shown in FIG. 24B.

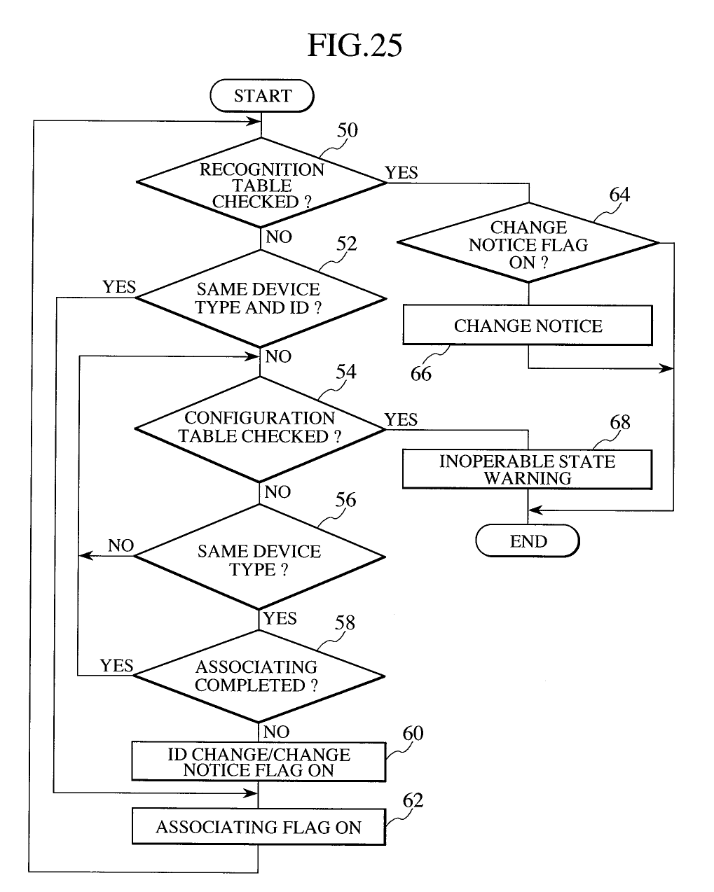

When the I/O device configuration table in FIG. 23 and the I/O device recognition table in FIG. 24 are set up for use, the management server 1 executes the process shown in FIG. 25.

FIG. 25 is a flowchart of the state determination process for the OS disk image on the server 2. Each I/O number in the I/O device recognition table is selected and checked in sequence (step S50). Whether the I/O device matching to the I/O device type 16 and ID 17 of the selected I/O number is present in the I/O device configuration table is judged (step S52). If the I/O device type 16 and the ID 17 do not match, the contents of the I/O device configuration table are checked in sequence (step S54) and then whether the I/O device matching the I/O device type 16 exists in the I/O device configuration table is checked (step S56). Although each kind of information is described below with the I/O device type 16 representing all related items, checks are conducted upon a permissible update range of the information relating to the I/O devices being used by the OS disk image. This information includes the type of I/O device. If the I/O device matching the I/O device type 16 is present in the I/O device configuration table, whether the associating flag 13 corresponding to the I/O device type 12 in the I/O device configuration table is on is checked (step S58). If the associating flag 13 is off, the ID 17 of the particular I/O device in the I/O device recognition table is changed and the change notice flag 19 is turned on (step S60). Next, the associating flag 13 in the I/O device configuration table is turned back on. Upon completion of the associating process for all I/O devices in the I/O device recognition table, all changes concerning the I/O devices for which the change notice flag 19 is on are notified to an OS disk image changing program (steps S64, S66). The OS disk image changing program is provided in the management server 1 to change the OS disk image stored within an external storage device. Although the OS disk image changing program may be provided in the server 2, next time the OS disk image is to be further executed, the state determination process requires re-execution since the OS disk image within the external storage device is unchanged. If the associating process is inexecutable despite I/O device configuration table checking in step S54, the fact that the OS disk image that the server 2 is going to execute is inoperable is warned to the administrator via the user interface of the management server 1 (step S68).

A more specific example of the process of FIG. 25 is shown below. When I/O 1 in FIG. 24 is selected and the I/O device configuration table is checked (step S52), the associating flag is turned ON since the I/O device type 12 and ID 11 of the No. 1 I/O device are the same as those defined in FIG. 24. FIG. 23 shows this state. Next, I/O 2 in FIG. 24 is selected and the I/O device configuration table is checked (step S52). Since an I/O device matching in both I/O device type 12 and ID 11 is absent (step S52), since an I/O device matching only in I/O device type 12 (in this example, HBA) is present (step S56), and since the associating flag 13 is off, the ID 17 in the I/O device recognition table is changed and the change notice flag 19 is turned on. This state is shown as a change from WWN 2 (I/O 2 in FIG. 24A) to WWN 3 (I/O 2 in FIG. 24B). Similarly, the ID 17 of I/O 6 is changed from MAC 3 to MAC 2.

It has been described that the I/O device recognition table in FIG. 24A is created by copying. This is because, if original contents of the I/O device recognition table are changed in sequence, the I/O device recognition table will not be returnable to its original state if not all of the I/O numbers that the OS disk image is to use can be associated with the I/O devices of the server 2. When all I/O numbers that the OS disk image is to use can be associated with the I/O devices of the server 2, the contents of the I/O device recognition table that were changed in the work area can be rewritten into the contents of the original I/O device recognition table.

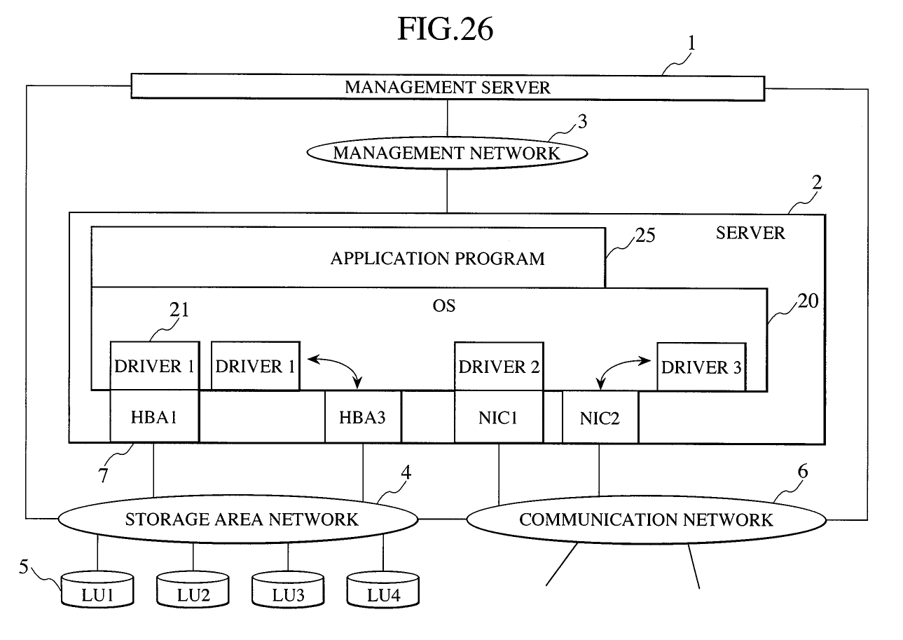

Thus, the contents as shown in FIG. 24B are assigned to the I/O device recognition table. When the OS disk image with any changes based on these contents of the I/O device recognition table is loaded into the server 2, the association between the I/O device driver 21 and the I/O device 7 will be as in the system configuration of FIG. 26. More specifically, the I/O device driver 21 and the I/O device 7 will be newly associated with each other, as denoted by a bi-directional arrow.

According to the present embodiment, before the OS disk image is executed, the I/O device configuration of the server which is going to execute the OS disk image can be checked for matching thereto.

Traditionally, OS disk images have been used upon the premise that once the need has arisen to alter part of the OS disk image, the entire disk image is to be regenerated. If the partial alteration is that of an application program, the regeneration is absolutely necessary, but the fact that the regeneration is also required when a change occurs in the I/O device configuration as an execution environment of the server results in deteriorated convenience. According to the present embodiment, even if the I/O device configuration of the server does not match (or include) that of the OS disk image, convenience conventionally unobtainable can be achieved since changing the setup information will increase cases in which the mismatch is properly processable.

### Fourth Embodiment

The first embodiment is intended to examine, immediately before an OS disk image is assigned, whether the OS disk image operates properly on the physical server specified by the administrator or the like. In the first embodiment, when a multi-server assignment state is to be changed or when an immediate assignment change is necessary, it takes time from the administrator's instruction for OS disk image assignment, until this assignment has been found to be executable. The present embodiment, therefore, focuses upon I/O devices, in particular, and implements faster assignment of the OS disk image to the physical server by the administrator.

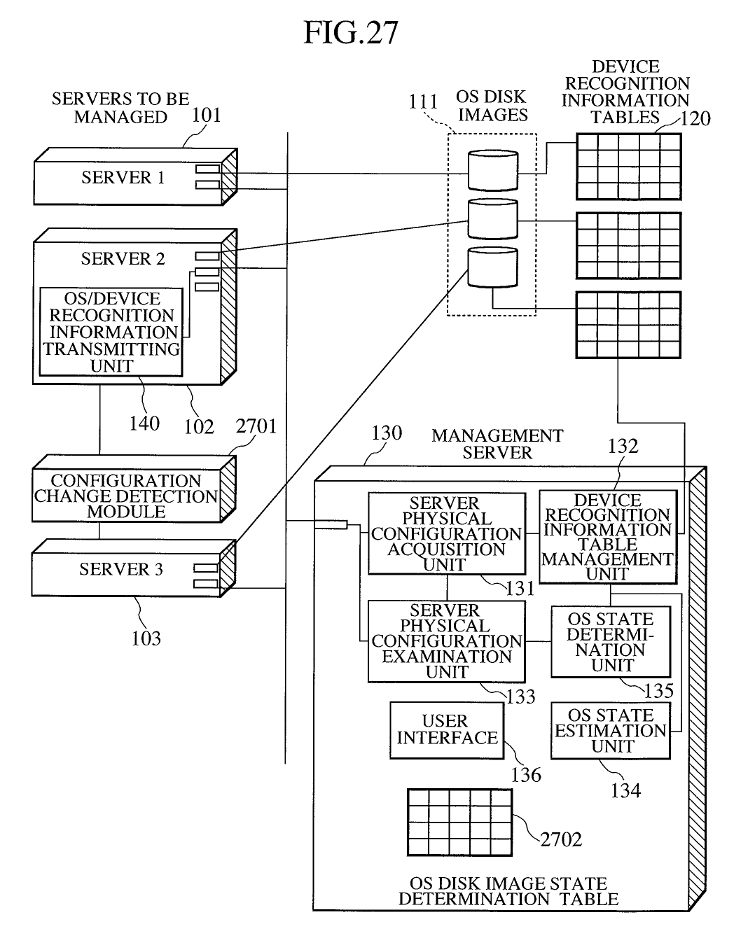

FIG. 27 shows an example of a system configuration according to the present embodiment. The embodiment incorporates a server configuration change detection module 2701 as a device in addition to the configuration employed in the first embodiment. In addition, an OS disk image state determination table 2702 is added to the management server 130.

The server configuration change detection module 2701, intended to manage a physical configuration of more than one server to be managed, includes a CPU and a memory and is configured as a device capable of executing a predefined program. The server configuration change detection module 2701 also has a network interface function to communicate with the management server and exchange data therewith. In addition, when I/O devices present on the server to be managed are added, the server configuration change detection module 2701 further performs a function that detects a configuration of the added I/O devices. In an example of detection, when an I/O device is inserted into a slot, a microcode present on the I/O device transmits an interrupt to a dedicated bus and then the server configuration change detection module 2701 acquires the interrupt. At this time, the server configuration change module functions to acquire configuration information of the server which has caused the interrupt, and to acquire I/O device information using a method equivalent to BIOS (Basic Input/output System) of the server under management. In other words, when a change is conducted upon the I/O device configuration of the server, the server configuration change detection module 2701 acquires, among all the change, only a section equivalent to the device configuration information that a server physical configuration examination unit 133 acquires. The server configuration change detection module further has a function that transmits the device configuration information, inclusive of the change only, to the management server in accordance with the same sequence as that of the examination OS.

Regardless of whether the OS is running on the server under management, the above detection flow can be executed just by operating the server configuration change detection module 2701 and the I/O device added to the server under management. The server configuration change detection module also detects removal of the I/O device from the slot. The OS disk image state determination table 2702 retains a state determination result list for each combination of a server and OS disk image managed by the management server. State determination results are recorded as a list consisting of an independent OS state determination rule associated with the OS disk image, and of the results of the judgment/determination in steps 1504 to 1509 of FIG. 15 with respect to the state determination rule. An example of an independent OS state determination rule is one rule denoted by each field of the state determination rule 304 shown in FIG. 12.

The following describes the operation flow in the present embodiment. The embodiment incorporates two changes relative to the first embodiment.

Firstly, upon a change of the hardware configuration of a device, the server configuration change detection module transmits the device configuration information, inclusive of the changed section only, to the management server, then a process flow only for that change by an OS state estimation unit 134 and the OS state determination process flow shown in FIG. 15 are executed, and OS state determination results are stored into the OS disk image state determination table 2702.

Secondly, instead of the OS state determination process flow being executed in step 1604 of FIG. 16 under a combination of a server and an OS disk image, results relating to a case of the least execution history, in the state determination process execution result list stored in the OS disk image state determination table 2702, are used as the determination results of step 1604 and following determination steps are conducted.

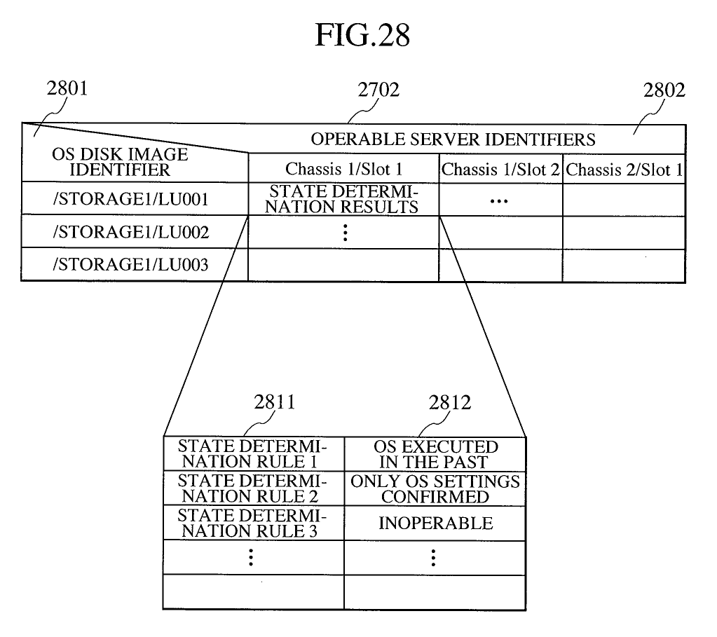

FIG. 28 shows an example of an OS disk image state determination table 2702 for storage of the OS state determination results based on the execution of the state determination process flow for the first change described above. The OS disk image state determination table 2702 is a table for storage of the state determination results relating to whether an OS disk image specified by an OS disk image identifier 2801 operates properly on a server specified by an operable server identifier 2802. The state determination results obtained by executing steps 1502 to 1511 of FIG. 15 in accordance with each rule included in the OS state determination rule of FIG. 12 are stored in the form of the state determination results for each server, as denoted by reference numbers 2811 and 2812.

What is claimed is:

1. An operational management system in a computer system including more than one server to be managed and an OS disk image adapted to operate on any one of the servers and managing association between the OS disk image and one of the servers to be managed, the system comprising:
means for acquiring I/O device recognition information including a combination of software control information and physical device configuration information, the software control information being included in the OS disk image relating to a first server to be managed, and being used for determining a device control behavior of an OS, the physical device configuration information being used for identifying an I/O device which applies the software control information;
means for acquiring physical device configuration information indicating an I/O device configuration of a second server to be managed; and
means for determining, on the basis of the I/O device recognition information and physical device configuration information acquired by the above means, whether the OS disk image operates properly when loaded into the second server and executed.

2. The system according to claim 1, wherein the operability determination means executes a predetermined confirmation procedure and conducts the determination based upon a successful execution history of the confirmation procedure.

3. The system according to claim 1, wherein the operability determination means has a plurality of predetermined confirmation procedures and includes means for recording information on which of the plurality of confirmation procedures has been executed.

4. The system according to claim 1, wherein, when the operability determination means determines that the OS disk image is operable, the OS disk image that has been associated with the first server becomes newly associated with the second server.

5. The system according to claim 1, wherein, when the operability determination means does not determine that the OS disk image is operable, the OS disk image that has been associated with the first server does not become associated with the second server.

6. The system according to claim 1, further comprising:
a device that detects addition and deletion of the I/O device of the second server to be managed; and
an OS disk image state determination table for storage of determination results obtained by the determination means;
wherein the determination means is adapted to:
in response to a notice of either addition or deletion of the I/O device, determine, on the basis of the I/O device recognition information and the physical device configuration information, whether the disk image operates properly when loaded into the second server and executed, and store determination results into the OS disk image state determination table; and
when the OS disk image that has been associated with the first server is newly associated with the second server, refer to the determination results stored in the OS disk image state determination table and then determine whether the OS disk image operates properly.

7. An operational management server that manages an OS disk image and a server in association with each other, the latter server being adapted to load and execute the OS disk image, the management server comprising:
an I/O device recognition table for storage of first information relating to an I/O device and used by the OS disk image;
an I/O device configuration table for storage of second information relating to an I/O device and included in the latter server; and
a processing unit for associating the OS disk image with the latter server when the first information stored in the I/O device recognition table is included in the second information stored in the I/O device configuration information.

8. The operational management server according to claim 7, wherein:
when part of the first information stored in the I/O device recognition table is not included in the second information stored in the I/O device configuration table, the processing unit changes the non-included information part in such a range that even after the change has been conducted, the OS disk image is maintained in an executable state on the server; and
when the first information including the changed information part is included in the second information stored in the I/O device configuration table, the processing unit associates the OS disk image with the server.

9. A method for operational management in a management server of a computer system including more than one server to be managed and an OS disk image adapted to operate on any one of the servers, the management server being used to manage association between the OS disk image and one of the servers to be managed, the method comprising the steps of:
acquiring I/O device recognition information including a combination of software control information and physical device configuration information, the software control information being included in the OS disk image related to a first server to be managed, and being used for determining a device control behavior of an OS, the physical device configuration information being used for identifying an I/O device which applies the software control information;
acquiring physical device configuration information indicating an I/O device configuration of a second server to be managed; and
determining, on the basis of the I/O device recognition information and physical device configuration information acquired by the above steps, whether the OS disk image operates properly when loaded into the second server and executed.

10. The operational management method according to claim 9, wherein the step of determining operability of the OS disk image includes executing a predetermined confirmation procedure and conducting the determination based upon a successful execution history of the confirmation procedure.

11. The operational management method according to claim 10, wherein the step of determining operability of the OS disk image includes having a plurality of predetermined confirmation procedures and recording information on which of the plurality of confirmation procedures has been executed.

12. The operational management method according to claim 9, wherein, when the operability determination means determines that the OS disk image is operable, the OS disk image that has been associated with the first server becomes newly associated with the second server.

13. The operational management method according to claim 9, wherein, when the step of determining operability of the OS disk image means does not determine that the OS disk image is operable, the OS disk image that has been associated with the first server does not become associated with the second server.

14. The operational management method according to claim 9,
providing a device that detects addition and deletion of the I/O device of the second server to be managed, and an OS disk image state determination table; wherein:
upon receipt of a notice of either addition or deletion of the I/O device, determination results on whether the disk image operates properly when executed are stored into the OS disk image state determination table; and
the determination results stored in the OS disk image state determination table are referred to and then the OS disk image becomes associated with the second server.

15. An operational management method allowing a management server to manage an OS disk image and a server in association with each other, the latter server being adapted to load and execute the OS disk image, the management server comprising an I/O device recognition table for storage of first information relating to an I/O device and used by the OS disk image, an I/O device configuration table for storage of second information relating to an I/O device and included in the latter server, the method comprising the steps of:
determining whether the first information stored in the I/O device recognition table is included in the second information stored in the I/O device configuration information; and
associating the OS disk image with the latter server when the first information stored in the I/O device recognition table is determined to be present in the second information stored in the I/O device configuration information.

16. The operational management method according to claim 15, wherein:
when part of the first information stored in the I/O device recognition table is not included in the second information stored in the I/O device configuration table, the processing unit changes the non-included information part in a range that even after the change has been conducted, the OS disk image is maintained in an executable state on the server; and
when the first information including the changed information part is included in the second information stored in the I/O device configuration table, the processing unit associates the OS disk image with the server.
